(19) United States
(12) Patent Application Publication
(10) Pub. No.: US 2021/0374295 A1
(43) Pub. Date: Dec. 2, 2021

(54) TECHNIQUES TO CUSTOM DESIGN PRODUCTS

(71) Applicant: Covestro LLC, Pittsburgh, PA (US)

(72) Inventors: Angela M. Beck, New Orleans, LA (US); David D. Steppan, Gibsonia, PA (US); Chetan Ghosalkar, McDonald, PA (US); Edward P. Squiller, Bridgeville, PA (US); Andrew Stadler, Allison Park, PA (US); Currie Crookston, Pittsburgh, PA (US); Kurt E. Best, Wexford, PA (US); John P. Forsythe, Allison Park, PA (US); James R. Charron, Pittsburgh, PA (US)

(21) Appl. No.: 17/286,722

(22) PCT Filed: Oct. 18, 2019
(86) PCT No.: PCT/US2019/056900

§ 371 Date: Apr. 19, 2021

Related U.S. Application Data
(60) Provisional application No. 62/748,762, filed on Oct. 22, 2018.
(60) Provisional application No. 62/774,985, filed on Dec. 4, 2018.

(51) Int. Cl. G06F 30/12; G06Q 30/08

(52) U.S. Cl. CPC G06F 30/12; G06F 2111/04; G06Q 30/08

(57) ABSTRACT

Disclosed are methods and interfaces for depicting a plurality of properties of a material, such as a haptic coating. In some aspects, gauges each expressing a property of the material may be displayed. Each property that collectively may describe the material may be defined along a gradient each of two opposing characteristics. Each of the physical properties may have an interrelationship with one or more of the other physical properties, such that when a particular value or quantity of one physical property is chosen, the other physical properties are constrained to a certain degree. The example gauges disclosed herein provide an interface that allows a user to easily understand these constraints and also allows for user friendly and intuitive manipulation of desired physical properties.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

This disclosure is generally related to a client-server based visualization techniques to custom design products based on a selection of a desired value for one or more properties of the material. More particularly, this disclosure is related to a web based graphical user interface to enable users to custom-design product configurations tailored to their unique application needs.

### BACKGROUND

Client-server based graphical user interfaces can be configured to enable users to custom-design product configurations tailored to their unique application needs. A plot may be employed to define a design space for a variety of products to reduce development time and provide self-service formulation assistance. According to one solution, a graphical depiction of a value of a property of a material can be produced by generating a plot defining a geometric shape and comprising a plurality of points arranged in a matrix, each of the points defining a value for at least two variables and a value of a property of the material. A visual representation of the value of the property of the material is displayed for at least some of the plurality of points in a range of indicia that represents a range of values of the property, and a pointer is displayed on the visual representation.

In this solution, however, the variables may, and often do, represent a value for an amount of a component in a composition. In some cases, however, the user may have no knowledge or understanding of available components for use in a composition.

As such, it would be desirable to provide an easy to use and intuitive interface that provides a graphical depiction of a plurality of properties of a material so that a user can select a desired combination of product properties for the user's application, even if the user has no knowledge or understanding of available components for use in a recipe that would produce such a product or any knowledge or understanding of the interrelationship of various physical properties with each other, such that when a particular value or quantity of one physical property is chosen, the other physical properties are constrained to a certain degree. Furthermore, it would be desirable to further be able to generate a recipe for producing a product that satisfies the selected combination of properties using available recipe components. In addition, it would, at least in some cases, also be desirable to transmit the recipe to one or more component suppliers.

### SUMMARY

In one aspect, the present disclosure provides methods of producing a graphical depiction of a plurality of properties of a material. These methods comprise: (a) generating, by a processing unit, a plurality of gauges each comprising a first extreme value and a second extreme value, wherein each gauge represents a property about the material, wherein the first extreme value is positioned at one end of the gauge and the second extreme value is positioned at an opposite end of the gauge; (b) generating, by the processing unit, for at least some of the plurality of gauges, an interface configured to allow selection of a value or a value range in between the first extreme value and the second extreme value, wherein the selection of the value or the value range is visually expressed by displaying at least one of (i) a selection marker along the gauge at a position proportional to an amount of the value with respect to the first extreme value and the second extreme value and (ii) multiple selection markers along the gauge comprising: (1) a first selection marker at a position proportional to an amount of a minimum value of the value range with respect to the first extreme value and the second extreme value, and (2) a second selection marker at a position proportional to an amount of a maximum value of the value range with respect to the first extreme value and the second extreme value; (c) receiving, through the interface, a selection of the value or the value range for a first gauge among the plurality of gauges; (d) causing display of the selected value or value range in the first gauge using the interface by displaying at least one of (i) the selection marker along the gauge at the position proportional to the amount of the value with respect to the first extreme value and the second extreme value, and (ii) the first selection marker along the gauge at the position proportional to the amount of the minimum value of the value range with respect to the first extreme value and the second extreme value, and the second selection marker at the position proportional to the amount of the maximum value of the value range with respect to the first extreme value and the second extreme value; (e) in response to the received selection, generating, by the processing unit, a plurality of value ranges for at least one of the other gauges other than the first gauge, wherein each of the value ranges represents a valid range of each respective property that is possible for the material, given that the selection of the value or the value range for the first gauge is a constraint that must be present in the material; and (f) causing display of the plurality of value ranges for the at least one of the other gauges at a position proportional to an amount of the value of the ranges with respect to the first extreme value and second extreme value of the at least one of the other gauges.

In another aspect, the present disclosure provides graphical user interfaces (GUIs) configured to provide a graphical depiction of a plurality of properties of a material. These GUIs comprise: (a) a plurality of gauges each comprising a first extreme value and a second extreme value, wherein each gauge represents a property about the material, wherein the first extreme value is positioned at one end of the gauge and the second extreme value is positioned at an opposite end of the gauge; and (b) for at least some of the plurality of gauges, an interface configured to allow selection of a value or a value range in between the first extreme value and the second extreme value, wherein the selection of the value or the value range is visually expressed by displaying at least one of (i) a selection marker along the gauge at a position proportional to an amount of the value with respect to the first extreme value and the second extreme value, and (ii) multiple selection markers along the gauge comprising: (1) a first selection marker at a position proportional to an amount of a minimum value of the value range with respect to the first extreme value and the second extreme value, and (2) a second selection marker at a position proportional to an amount of a maximum value of the value range with respect to the first extreme value and the second extreme value. In addition, these GUIs are configured to: (i) receive a selection of the value or the value range for a first gauge among the plurality of gauges; (ii) cause display of the selected value or value range in the first gauge using the interface by displaying at least one of (1) the selection marker along the gauge at the position proportional to the amount of the value with respect to the first extreme value and the second extreme value, and (ii) the first selection marker along the gauge at the position proportional to the amount of the minimum value of the value range with respect to the first extreme value and the second extreme value, and the second selection marker at the position proportional to the amount of the maximum value of the value range with respect to the first extreme value and the second extreme value; (iii) in response to the received selection, generate a plurality of value ranges for at least one of the other gauges other than the first gauge, wherein each of the value ranges represents a valid range of each respective property that is possible for the material, given that the selection of the value or the value range for the first gauge is a constraint that must be present in the material; and (iv) cause display of the plurality of value ranges for the at least one of the other gauges at a position proportional to an amount of the value of the ranges with respect to the first extreme value and second extreme value of each of the other gauges.

### FIGURES

FIG. 1 provides an example gauge interface showing five different physical properties of a genre of coatings, according to some aspects.

FIG. 2 shows an example of a response by the haptic gauge interface once one of the gauges is selected for a particular value, according to some aspects.

FIG. 3 shows how the interface allows for multiple physical properties of a product to be selected, provided the selections fall within acceptable ranges of each other, according to some aspects.

FIG. 4 shows how a different second gauge may be selected after the first soft feel gauge was selected, according to some aspects.

FIG. 5 shows how three gauges may be selected, according to some aspects.

FIG. 6 shows a different set of three gauges that may be selected, according to some aspects.

FIG. 7 shows how four of the five gauges may be selected, according to some aspects.

FIG. 8 shows an example gauge interface showing nine different physical properties of a genre of coatings, according to some aspects.

FIG. 9 shows an example of a response by a gauge interface once a user-defined value range is selected for two of the gauges, according to some aspects.

FIG. 10 shows an example of a response by a gauge interface once a pre-defined value range is selected for two of the gauges, according to some aspects.

FIG. 11 shows an example of a response by a gauge interface once a user makes an optimization selection for one of the gauges, according to some aspects.

FIG. 12 shows a chart of multiple coating configurations and their respective physical properties, according to some aspects.

FIG. 13 shows another chart that visually illustrates any number of coating formulations or recipes, according to some aspects.

FIG. 14 shows a basic block diagram of a user or customer interfacing with the digital formulation service, which may be manifested in a computerized module.

FIG. 15 shows one model for how the digital formulation service may complete a custom coating order, according to some aspects.

FIG. 16 shows a second model in a variation of how the digital formulation service may complete a custom coating order, according to some aspects.

FIG. 17 shows another model in another variation of how the digital formulation service may complete a custom coating order, according to some aspects.

FIG. 18 shows how after generating a recommended material configuration that satisfies the user specified constraint(s), the digital formulation service module may be configured to interface with one or more purchasing/trade platforms that supply the ingredients needed to generate the recommended formulation, according to some aspects.

FIG. 19 shows a block diagram for the purchase mechanisms that can be extended to include convenient and more streamlined features that can automatically connect to appropriate suppliers.

FIG. 20 illustrates an example computing environment wherein one or more of the provisions set forth herein may be implemented.

FIGS. 21A and 21B combined show a logic flow diagram of a logic configuration or process of a method of producing a graphical depiction of a value of a property of a material according to some aspects of this disclosure.

### DESCRIPTION

In one aspect, the present disclosure is directed to a client-server based visualization mapping techniques that employs graphical user interfaces configured to enable users to custom-design product configurations tailored to their unique application needs. An easy to use and intuitive interface may be employed that provides a graphical depiction of a plurality of properties of a material so that a user can select a desired combination of product properties for the user's application, even if the user has no knowledge or understanding of available components for use in a recipe that would produce such a product or any knowledge or understanding of the interrelationship of various physical properties with each other, such that when a particular value or quantity of one physical property is chosen, the other physical properties are constrained to a certain degree. The graphical user interface may be on a client that runs a web server in a cloud based system.

Before describing various aspects of client-server based visualization mapping techniques, the disclosure turns briefly to a description of the design of experiment technique that may be used to build a database of data used to generate gauges to enable users to custom-design various products by manipulating a value within at least one gauge and providing a display of value ranges for other gauges on a screen or display of a computer, tablet, smartphone, or other web based client appliance. In one aspect, a statistical software application known under the trade name of Design-Expert from Stat-Ease Inc. may be employed to create and analyze a design of experiments to generate model equations that drive the t interfaces according to the present disclosure. Other statistical software applications for generating and analyzing a design of experiments include, for example, statistical software applications known under the trade name ECHIP, JMP, and Minitab.

It will be appreciated that there are many considerations when creating, executing, and analyzing a design of experiments. The methodology used to create the interfaces described herein provide an example of one way in which experimental data can be used to drive an interactive, graphical interface. In one aspect, computer generated data may be employed to drive the interface in accordance with the present disclosure. In other aspects, real measurement data may be employed to drive the interface. In yet another aspect, real measurement data may be employed to drive the interface and computer generated data may be employed to fill in any gaps in the real measurement data.

In one formulation generation example, a polyurethane coating, comprising an A and B side, is analyzed. The system is evaluated using a two-mixture design, with one mixture (Mixture 1) based on the relative amounts of three components and the other mixture (Mixture 2) based on the relative amounts of two components. A design of experiments formulation data set can be created using the DesignExpert software application. Upon specifying the design space and generating a set of formulations, the coatings are prepared and cured on appropriate test substrates. Each property is then measured and recorded in a Design-Expert data table. The formulation data set can be stored in a database.

Once the data has been accumulated, it can be analyzed to develop model equations. There are a variety of approaches to selecting the terms for the final model, for example, a threshold p-value can be chosen, an information criterion statistic can be minimized (such as the Corrected Aikake's Information Criterion or the Bayesian Information Criterion), or another statistic can be optimized, such as R-square adjusted or Mallow's Cp. Additionally, a validation set of points may be withheld from the model building process, with the final model chosen as the best fit (again, a variety of criteria can be used to determine best fit) of the validation set. These approaches can be performed in a stepwise approach with Forward selection, that is starting with a model with no terms and stepwise adding one at a time, Backward selection, starting with the full model and reducing terms one by one, or one that mixes Forward and Backward selection. The addition and reduction of terms is stopped when the chosen criteria is met. Commercially available statistical software packages support these, as well as other, approaches.

In one example, computer generated data may be employed as input for the responses. For each response, the significant model terms may be identified by starting with a full quadratic model and performing a backwards stepwise elimination with minimization of the Bayesian Information Criterion (BIC) as the stopping rule. Standard least squares regression can then be used to determine the coefficients of the significant model terms for the final model equation. The following process demonstrates at a high level the use of this approach for the first response, “Property 1,” in the Design-Expert software application.

A “Property 1” response is selected under the analysis tree. An initial model is chosen and a response fit summary is selected. Model reduction may be done manually or using an automated method. If an auto-select model is selected, model selection criteria are entered into the automatic model selection window. Upon completion of the above process, the selected design of experiments model is accepted and the analysis of variance (ANOVA), a statistical method in which the variation in a set of observations is divided into distinct components, is selected. The application (such as the Design-Expert application) then performs an R-Squared analysis and provides the user an opportunity to review the R-Squared analysis, adjust the R-Squared, and predetermine the R-Squared values to ensure the values are within the range desired for the response being evaluated. The application (such as the Design-Expert application) calculates a variety of statistics to assess the fit of the selected model to the data, including, for example, R-Squared, Adjusted R-Squared, Predicted R-Squared, standard deviation, and PRESS (Predicted Residual Error Sum of Squares). In addition, the application provides a Diagnostics section, where the validity of the ANOVA assumptions can be evaluated, the data can be examined for outliers from the model and other such important model building concerns can be gauged. Finally, the model graphical depictions may be selected and the final equation in terms of real components may be evaluated. The final equation may be employed to populate a data table for the ternary map interface for all properties.

A model for generating predictive values of properties of materials includes, without limitation, design of experiments, regression analysis of a data set, an equation, machine learning, or artificial intelligence, and/or any combination thereof. In one aspect, the model used to generate the values of the properties of a material is generated from a design of experiment technique. In other aspects, models for generating predictive values of properties include a statistical analysis of unstructured data, such as that generated by a historian of a distributed control system of a chemical manufacturing plant. For example, models of the dependence of polymer viscosity, such as the viscosity of a polymer modified polyol (“PMPO”), on solids content and other variables that are reasonably accurate within small ranges may be generated from such unstructured data. In other aspects, artificial intelligence methods may be employed to mine a large number of experimental systems in a company's lab notebook system and research papers. In other aspects, an analytical model may be generated based on scientific first principles. For example, a graphical user interface (GUI) may be configured to display pressure at a given volume and temperature of mixtures of multiple gases, predicted by a non-ideal gas law, for example.

Various material properties are tabulated in Table 1 below. The interfaces described herein can be used to design products having a particular material property, short or long, as described in Table 1. Properties include, without limitation, physical properties often associated by those ordinarily skilled in the coatings art, such as Soft Feel, 5 Finger Scratch Resistance, Solvent (such as Diethyltoluamide (DEET) IPA, Skydrol, Betadine, Gasoline, etc.) Resistance, Coefficient of Friction, Work Time, Walk on Time, Dry to Touch (Surface and Mar Free), Taber Abrasion Resistance, Pendulum Hardness (1-day, 3-day, 7-day), Micro Hardness, Elastic Modulus, MEK Rub, Linear Abrasion, Hot Tire Resistance, (Dry Initial, Dry Recovery, Wet Initial, Wet Recovery), Gloss, Delta E. Pot Life, Weathering Resistance (measured in terms of gloss retention and yellowing), Corrosion Resistance (such as salt fog resistance), Viscosity, and various adhesion properties, as well as properties often associated by those ordinarily skilled in the art of polyurethane foams, such as flexible polyurethane foams, such as Density, Indentation Force Deflection 25%, Indentation Force Deflection 40%, Indentation Force Deflection 65%, Tensile Strength, Elongation, Tear Strength, Maximum Temperature, Compression Strength 90%, Humid Age Compression Set 75%, Fatigue Loss, among others, for example.

TABLE 1
Material Properties

| Product | Property | Units | Min | Max |
|---|---|---|---|---|
| Coatings | Soft Feel | N/A | 0.25 | 4.4 |
| | 5 Finger Scratch Resistance | N/A | 0.73 | 6 |
| | Diethyltoluamide (DEET) Solvent | N/A | 1.8 | 4.9 |
| | Resistance | | | |
| | Coefficient of Friction | N/A | 2 | 5.5 |
| Foams | Density | pcf | 0.8 | 6 |
| | Indentation Force Deflection 25% | lbs | 5 | 200 |
| | Indentation Force Deflection 40% | lbs | 10 | 300 |
| | Indentation Force Deflection 65% | lbs | 10 | 450 |
| | Tensile Strength | psi | 0 | 40 |
| | Elongation | % | 40 | 350 |
| | Tear Strength | pli | 0 | 4 |
| | Maximum Temperature | deg F. | 200 | 400 |
| | Compression Strength 90% | % | 0 | 95 |
| | Humid Age Compression Set 75% | % | 0 | 95 |
| | Fatigue Loss | % | 0 | 75 |

As indicated, in some aspects, the present disclosure provides GUIs configured to provide a graphical depiction of a plurality of properties of a material, such as a coating, an adhesive, a sealant, an elastomer, a sheet, a film, a foam, a binder, or any organic polymer or other polymeric materials. Certain coatings, for example, may be defined by several physical properties, with each property being defined along a gradient of opposing characteristics. Each of the physical properties may have an interrelationship with one or more of the other physical properties, such that when a particular value or quantity of one physical property is chosen, the other physical properties are constrained to a certain degree. Knowing how much of each physical property may cause the other physical properties to be constrained, may be based on empirical research and a predetermined number or types of materials (e.g., haptic coatings) available for use. For example, all known materials or composites that possess a certain value of a physical property may collectively be known to possess only a particular range of a second physical property, and therefore when the first physical property is selected at a certain value or a certain value range, only certain ranges of a second and subsequent physical properties may be available. The gauges disclosed herein provide an interface that allows a user to easily understand these constraints and also allows for user friendly and intuitive manipulation of desired physical properties. These interfaces may be generated and operated by one or more processing units.

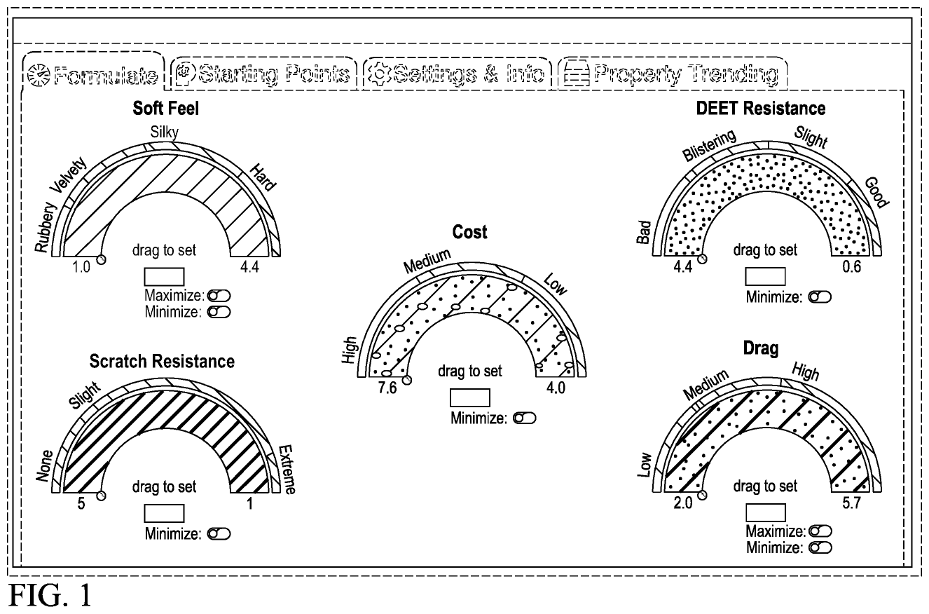

Referring to FIG. 1, an example gauge interface showing five different physical properties of a genre of coatings is shown, according to some aspects. In this example, the gauges have a rounded, “half-circle” shape, though gauges of any of a variety other shapes can be readily envisioned, such as circular (more than a half-circle) or linear gauges, among others. As will be appreciated, a “gauge” is an instrument with a graduated scale for measuring or indicating a value. For example, in some cases, a “gauge” may be in the form of a dial having a graduated scale and a pointer.

In this example interface, the gauges represent different qualitative descriptions for haptic coatings (also known as soft touch or soft feel coatings), which is a category of coatings that provide a desired luxurious feel to an ordinary substrate such as metal, plastic, or paper. It will be appreciated, however, that gauges representing quantitative values of material properties could be employed in addition to, or in lieu of, gauges representing different qualitative descriptions. Haptic coatings are used in various applications, including, but not limited to, consumer electronics, packaging, appliances, automobile interiors, and athletic footwear. In FIG. 1 four qualitative descriptions that represent different physical properties of a haptic coating: how soft (or hard) the coating feels, scratch resistance, smoothness (drag) and its DEET resistance, i.e., resistance to the insect repellent N,N-diethyl-meta-toluamide, are shown. It will be appreciated, however, that other descriptions, including various other physical properties, may be shown if desired depending on the particular application, interests of the user, and materials being evaluated (for example, different combinations of physical properties may be of interest for different categories of coatings, such as polyaspartic floor coatings, or other materials, such as adhesives, sealants or foams). Some exemplary, but non-limiting, physical properties that may be of interest are set forth in Table 1.

Referring again to FIG. 1, the four qualitative descriptions may be balanced against another descriptor, such as, for example, cost, which is the fifth gauge shown in FIG. 1. Each gauge allows for a value to be set across a range, where the maximum of one side represents one extreme, and the maximum of the opposite side represent the opposite extreme. Thus, each qualitative description of the haptic coating may be expressed as a numerical value, and the combination of the numerical values of the qualitative descriptions represents a particular combination of properties for a haptic coating. For example, the “Soft Feel” gauge can be set from a range of 1.0 to 4.4, where 1.0 represents the softest feel (“Rubbery”), while 4.4 represents the hardest feel. The other gauges include descriptions of what the various ranges represent, as shown. In the particular example interface illustrated in FIG. 1, a user may click or otherwise select a point on a gauge to set a value of that particular qualitative description. The interface also allows for dragging the selection along the gauge to change the value. This example interface also includes some additional displays that may be selectable by clicking or otherwise selecting the tabs at the top of the interface, according to some aspects.

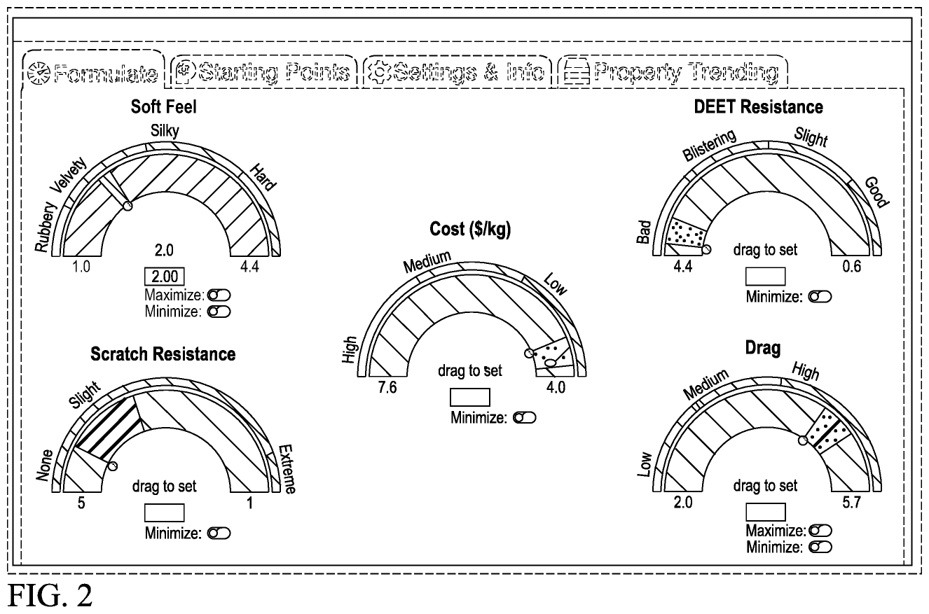

Referring to FIG. 2, shown is an example of a response by the interface once one of the gauges is selected for a particular value, according to some aspects. In this example, the user has selected a “Soft Feel” value of 2.0, which, in this example, represents a feel somewhere between “Velvety” and “Silky.” As a result, the interface according to some aspects automatically displays a set of ranges for all of the other gauges that represent valid values for the other qualitative descriptions based on the selected value for “Soft Feel”. In other words, all known haptic coatings and combinations of coatings having a soft feel of 2.0 correspondingly possess the other physical characteristics in only a set of possible ranges, as shown in the specified ranges of the other gauges of FIG. 2. The gauge for cost is also constrained to the specified range on the low end, near 4.0, as shown. Thus, by specifying one value for one of the qualitative descriptions of the haptic coating, the interface automatically constrains the possible values of the other qualitative descriptions as shown in their respective gauges. This may be based on a database of known haptic coatings and their various physical properties. All of the types of coatings that satisfy the first specified constraint are kept in consideration, and all of their qualitative descriptions are then effectively highlighted in the remaining ranges of the interface gauges.

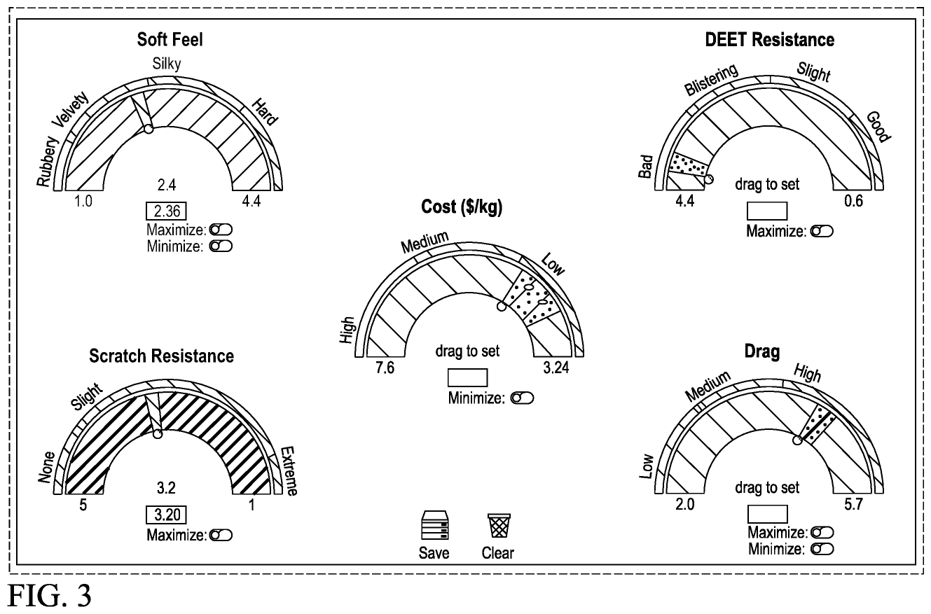

Referring to FIG. 3, in some aspects, the interface allows for multiple qualitative descriptions of a coating to be selected, provided the selections fall within acceptable ranges of each other. In this example illustration, after the soft feel property has been selected at 2.4, as before, the other gauges automatically update to show valid ranges of all haptic coatings that satisfy this first constraint. The user may then select a second value within one of the valid ranges in one of the other properties. In this case, a scratch resistance value of 3.2 has been selected that was within the automatically selected range for available scratch resistance after the first value of the soft feel property was selected. Therefore, as shown, two of the gauges are now specifically set. Correspondingly, the other three gauges show updated ranges that satisfy both selections. This may mean that the updated ranges are smaller than the earlier ranges that needed to satisfy only one constraint.

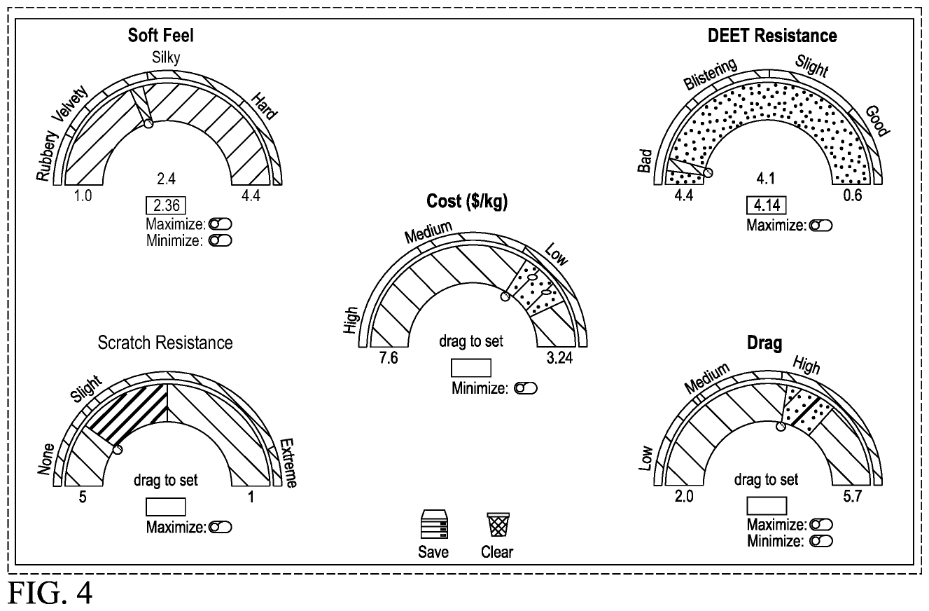

Referring to FIG. 4, the example illustration shows how a different second gauge may be selected after the first soft feel gauge was selected, according to some aspects. Here, the DEET resistance gauge was selected at a value falling within a valid range for coatings that satisfied the first selection under the soft feel gauge. Correspondingly, the other three gauges automatically update and show valid ranges that satisfy both selected constraints. As before, the updated ranges may be smaller than the earlier ranges that needed to satisfy only one constraint.

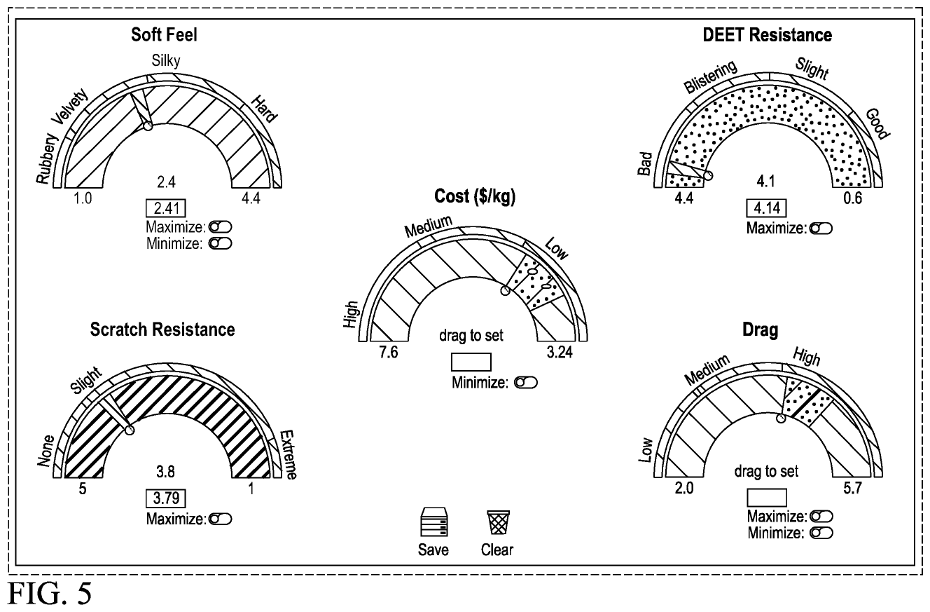

Referring to FIG. 5, the example illustration shows how three gauges may be selected, according to some aspects. After two gauges are selected like shown in FIG. 3 or 4, a third gauge may be selected for a value that satisfies the remaining range for the third gauge. For example, after selecting a first value for soft feel and selecting a second value for DEET resistance that was within an updated valid range given the first selection, a user may select a third value for scratch resistance that is within the updated range based on the first two selections. Correspondingly, the last two gauges may have the valid ranges updated that satisfy all three of the selected ranges in the first three gauges. Again, these ranges may be smaller than if only one or two gauges were selected with specified values.

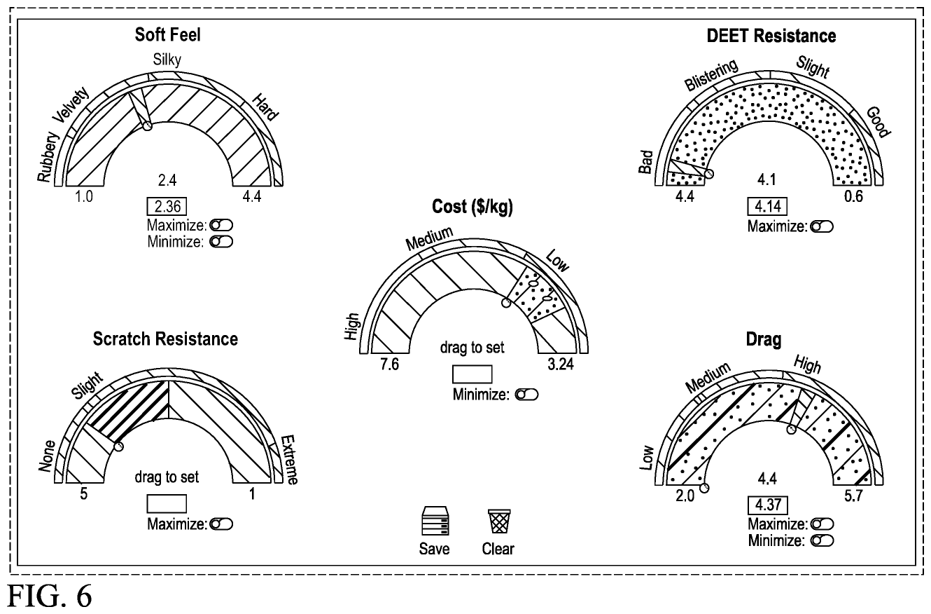

Referring to FIG. 6, the example illustration shows a different set of three gauges that may be selected, according to some aspects. As shown the soft feel, DEET resistance, and drag gauges are selected, and the remaining scratch resistance and cost gauges correspondingly show valid ranges of coatings that satisfy the already selected three values of the first three gauges. Similarly, other combinations of three gauges may be selected that are not shown, and implementations are not so limited.

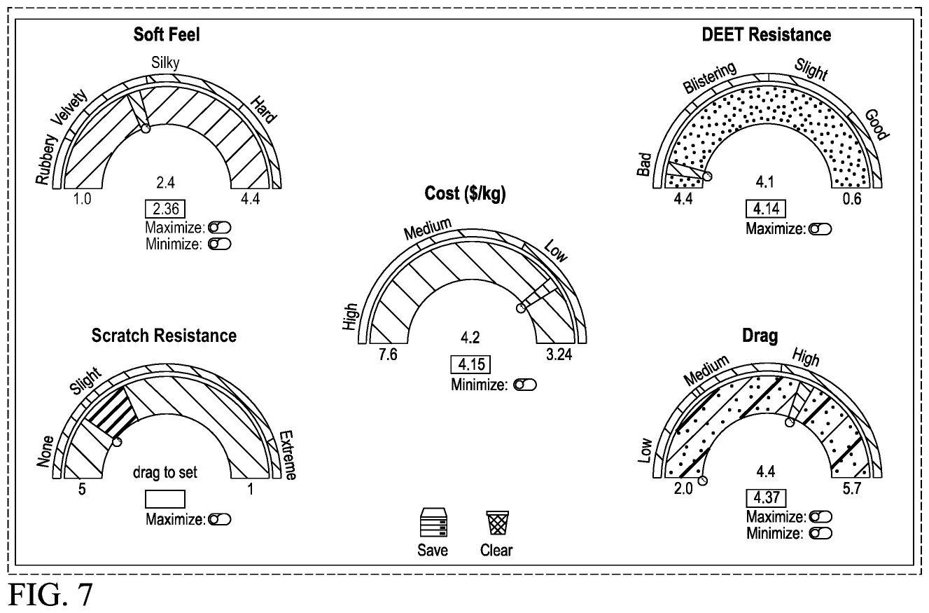

Referring to FIG. 7, the example illustration shows how four of the five gauges may be selected, according to some aspects. Continuing with the analysis of the previous examples, after selecting a third value in a third gauge, a fourth value may be selected in a fourth gauge that falls within the updated range satisfying all three previously selected values in the first three gauges. Thus, in this example, all gauges except the scratch resistance gauge have selected values, and the remaining gauge shows a final range that represents coatings that satisfy all of the selected values for the other physical properties. Since all of the other gauges have selected values and only one gauge remains unselected, this range may be the smallest range in the selected progression.

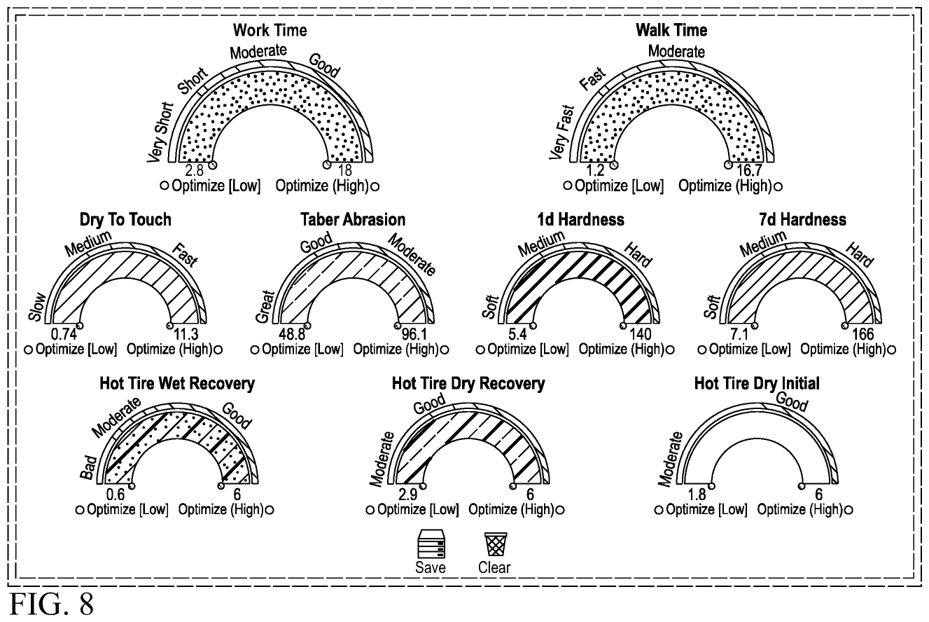

Another implementation of the methods and GUIs of this specification will now be described, beginning with FIG. 8. Referring to FIG. 8, an example gauge interface showing nine different physical properties of a genre of coatings is shown, according to some aspects. In this example, as with the implementation previously described, the gauges have a rounded, “half-circle” shape, though gauges of any of a variety other shapes can be readily envisioned, such as circular (more than a half-circle) or linear gauges, among others.

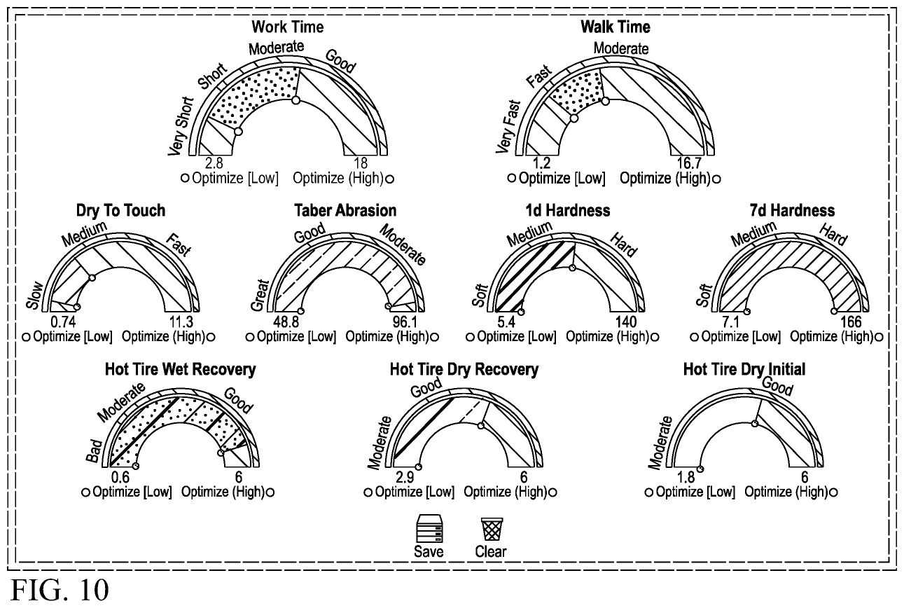

In this example interface, the gauges represent different descriptions for certain floor coatings, which is a category of coatings that provide a desired a decorative appearance and protection to floors, such as those used on driveways or garages that might be subjected to automobile traffic. It will be appreciated, however, that in this implementation gauges representing values of various material properties could be employed in addition to, or in lieu of, gauges those illustrates in the Figures. In FIG. 10, for example, nine descriptions that represent different physical properties of certain floor coatings: work time, walk time, dry to touch time, Taber abrasion resistance, 1 day hardness, 7 day hardness, and various measures for hot tire resistance, are illustrated. It will be appreciated, however, that other descriptions, including various other physical properties, may be shown if desired depending on the particular application, interests of the user, and materials being evaluated (for example, different combinations of physical properties may be of interest for different categories of coatings, such as polyaspartic floor coatings, or other materials, such as adhesives, sealants or foams). Some exemplary, but non-limiting, physical properties that may be of interest are set forth in Table 1.

Although not depicted in FIG. 8, the descriptions may be balanced against another descriptor, such as, for example, cost, as was done with respect to the aspect described with reference to FIG. 1. As seen in FIG. 8, each gauge allows for a value to be set across a range, where the maximum of one side represents one extreme, and the maximum of the opposite side represent the opposite extreme. Thus, each description of the coating may be expressed as a numerical value, and the combination of the numerical values of the descriptions represents a particular combination of properties for the coating. For example, the “Dry to Touch” gauge can be set from a range of 0.74 to 11.3, where 0.74 represents the shortest dry to touch time, while 11.3 represents the longest dry to touch time. The other gauges include descriptions of what the various ranges represent, as shown. In the particular example interface illustrated in FIG. 8, a user may click or otherwise select points on a gauge to set a value range of that particular description. The interface also allows for dragging the selections along the gauge to change the value range. This example interface also includes some additional displays that may be selectable by clicking or otherwise selecting the tabs at the top of the interface, according to some aspects, which will be described in more detail below.

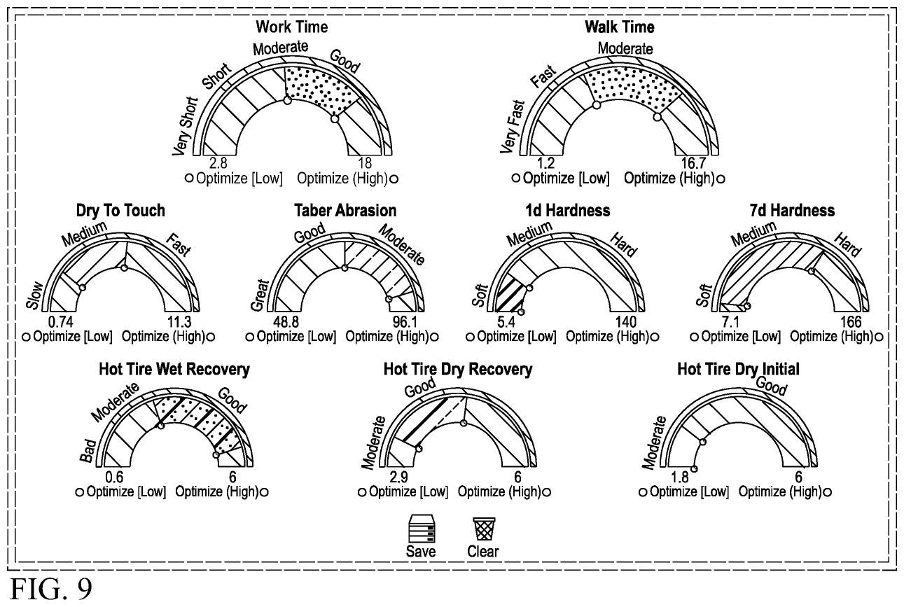

Referring to FIG. 9, shown is an example of a response by the interface once one of the gauges is selected for a particular value range, according to some aspects. In this example, the user has selected a “Work Time” value range that bridges between “Moderate” and “Good”, which in this particular example was a range of 10.4 to 15.4, that was created by the user and is thus a user-defined value range. As a result, the interface according to some aspects automatically displays a set of ranges for all of the other gauges that represent valid values for the other descriptions based on the selected value range for “Work Time”. In other words, all known floor coatings and combinations of coatings having a “Work Time” of 10.4 to 15.4 correspondingly possess the other physical characteristics in only a set of possible ranges, as shown in the specified ranges of the other gauges of FIG. 9. Thus, by specifying one value range for one of the descriptions of the floor coating, the interface automatically constrains the possible values ranges of the other descriptions as shown in their respective gauges, that are valid with the specified value range. This may be based on a database of known coatings and their various physical properties. All of the types of coatings that satisfy the first specified constraint (value range) are kept in consideration, and all of their descriptions are then effectively highlighted in the remaining ranges of the interface gauges.

Referring to FIG. 10, shown is an example of a response by the interface once one of the gauges is selected for a particular value range, according to some aspects. In this example, the user has selected a system pre-set “Walk Time” value range that is “Fast” by simply clicking on the gauge helmet labeled “Fast” in the “Walk Time” gauge. In this particular example, the system has pre-set a “Walk Time” that is “Fast” as one that has a value of 4.8 to 8.0. Thus, instead of creating a user-defined value range, the user may simply elect to utilize a system pre-set value range. As a result of this selection, the interface according to some aspects automatically displays a set of ranges for all of the other gauges that represent valid values for the other descriptions based on the selected “Fast” value range for “Walk Time”. In other words, all known floor coatings and combinations of coatings having a “Walk Time” that is “Fast” as defined by the system correspondingly possess the other physical characteristics in only a set of possible ranges, as shown in the specified ranges of the other gauges of FIG. 10. Thus, by specifying one value range for one of the descriptions of the floor coating, the interface automatically constrains the possible values ranges of the other descriptions as shown in their respective gauges. This may be based on a database of known coatings and their various physical properties. All of the types of coatings that satisfy the first specified constraint (value range) are kept in consideration, and all of their descriptions are then effectively highlighted in the remaining ranges of the interface gauges.

Although not depicted in FIG. 9 or 10, in some aspects, the interface allows for multiple descriptions of a coating to be selected, provided the selections fall within acceptable ranges of each other. With respect to FIG. 10, for example, after the “Walk Time” value range has been selected at “Fast,” as before, the other gauges automatically update to show valid ranges of all coatings that satisfy this first constraint. The user may then select a second value or value range within one of the valid ranges in one of the other properties. In this case, for example, a value or value range for “Work Time” within the range of 5.06 to 10.67 could be selected that is within the automatically selected range for available “Work Time” values after the first value range of “Walk Time” was selected. Therefore, two of the gauges would now be specifically set. Correspondingly, the other gauges would show updated ranges that satisfy both selections. This may mean that the updated ranges are smaller than the earlier ranges that needed to satisfy only one constraint. In general, if multiple value ranges of multiple gauges are specified, the remaining gauges not having specified value ranges are automatically constrained by the interface to the possible value ranges that are valid with the combination (intersection) of the specified value ranges.

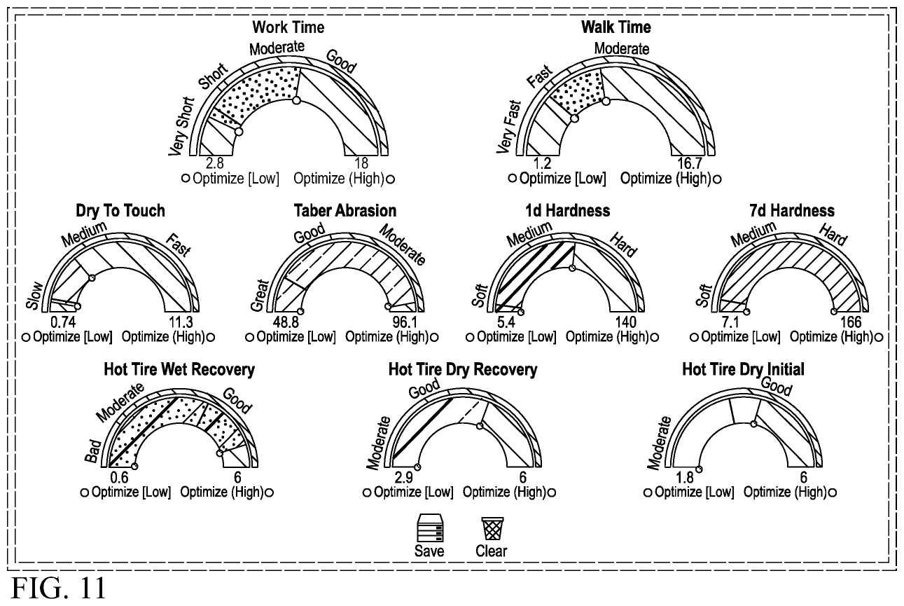

FIG. 11 illustrates an example of formulation optimization according to some aspects. Here, an optimized (low) value for “Walk Time” was selected. In this example, by the user selecting “Optimized (Low)” beneath the “Walk Time” gauge, the display of the selected optimized value, in this case by a selection marker that depicted as a solid line, is shown at the minimum value for the selected value range, in this case a value of 4.8. In response to this selection, the processing unit generates a value for the other gauges other than the first gauge, wherein each of the values represents a valid value of each respective property that is possible for the material, given that the selection of the optimized value for the first gauge is a constraint that must be present. In addition, the generated values for the other gauges is displayed by a selection marker that is depicted as a solid line running perpendicular to the arc of the gauges in this case, at a position proportional to an amount of the value of the ranges with respect to the first extreme value and second extreme value of the at least one of the other gauges.

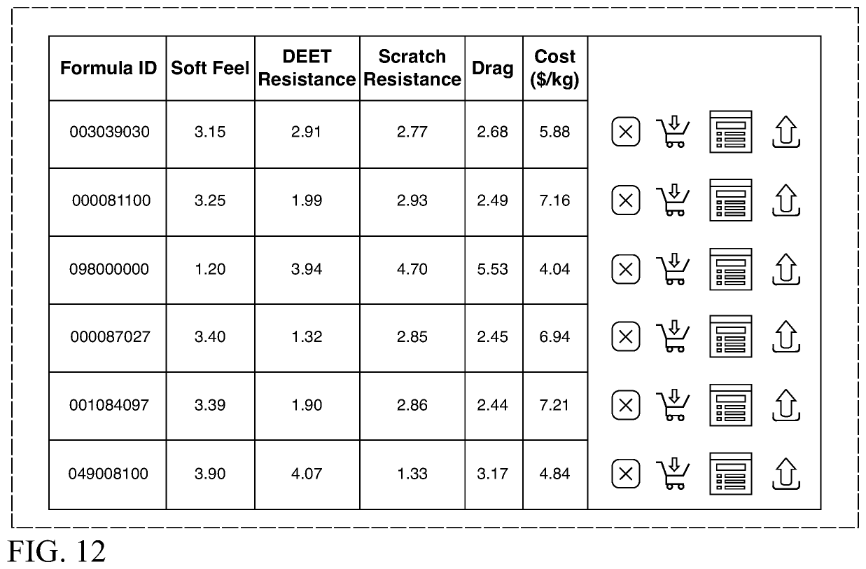

Referring to FIG. 12, the example illustration shows a chart identifying multiple coating compositions and their respective qualitative descriptions, according to some aspects. As shown, each row identifies a particular coating formulation and the values of the qualitative descriptions for each coating composition. The numerical values may correspond to the numerical values in the respective gauges, as shown in any of FIGS. 1-11. The coating compositions represent recipes that may be generated by the methods of this disclosure for producing a coating that satisfies the valid ranges of each of the physical properties.

As will be appreciated, coating compositions, such as those identified by “Formula ID” in FIG. 12 can comprise any of a variety of components, such as resins, crosslinking agents, colorants, and/or various other additives. In some embodiments, the compositions include a polyurethane dispersion, such as a waterborne polyurethane dispersion. Polyurethane dispersions (PUDs) offer several advantages over other technologies such as acrylics and acryl amide copolymers, polyvinyl pyrrolidone, and PVP/VA copolymers. Such advantages include water compatibility, ease of formulating low VOC sprays, water resistance and excellent film forming ability. PUDs and methods of making them may be found for example in Polyurethanes—Coatings, Adhesives and Sealants, Ulrich Meier-Westhues, Vincentz Network GmbH & Co., KG, Hannover, (2007), Ch. 3, the contents of which are incorporated herein by reference.

Suitable PUDs may, for example, contain: (A) at least one diol and/or polyol component (B) at least one di- and/or polyisocyanate component (C) at least one component including at least one hydrophilizing group (D) optionally mono-, di- and/or triamine-functional and/or hydroxylamine-functional compounds, and (E) optionally other isocyanate-reactive compounds.

Suitable diol- and/or polyol components (A) are compounds having at least two hydrogen atoms which are reactive with isocyanates and have an average molecular weight of, for example, 62 to 18000, such as 62 to 4000 g/mol. Examples of suitable structural components include polyethers, polyesters, polycarbonates, polylactones and polyamides. In some cases, the polyols (A) have 2 to 4, 2 to 3, or, in some cases, 2 hydroxyl groups. Mixtures of different such compounds are also possible. In some cases, the content of polyol component (A) in the polyurethane according to this disclosure is 20 to 95, particularly preferably 30 to 90, and most particularly preferably 65 to 90 wt. %.

Suitable as component (B) are any organic compounds which have at least two free isocyanate groups in each molecule, such as diisocyanates of the formula Y(NCO)₂, wherein Y represents a divalent aliphatic hydrocarbon radical having 4 to 12 carbon atoms, a divalent cycloaliphatic hydrocarbon radical having 6 to 15 carbon atoms, a divalent aromatic carbon radical having 6 to 15 carbon atoms or a divalent araliphatic hydrocarbon radical having 7 to 15 carbon atoms. Examples of such diisocyanates which are preferably used are tetramethylene diisocyanate, methylpentamethylene diisocyanate, hexamethylene diisocyanate, dodecamethylene diisocyanate, 1,4-diisocyanato-cyclohexane, 1-isocyanato-3,3,5-trimethyl-5-isocyanatomethyl-cyclohexane (IPDI, isophorone diisocyanate), 4,4′-diisocyanato-dicyclohexyl-methane, 4,4′-diisocyanato-dicyclohexylpropane-(2,2), 1,4-diisocyanatobenzene, 2,4-diisocyanatotoluene, 2,6-diisocyanatotoluene, 4,4′-diisocyanato-diphenylmethane, 2,2′- and 2,4′-diisocyanato-diphenylmethane, tetramethyl xylylene diisocyanate, p-xylylene diisocyanate, p-isopropylidene diisocyanate and mixtures of these compounds.

In addition to these simple diisocyanates, also suitable are those polyisocyanates which contain hetero atoms in the radical linking the isocyanate groups and/or have a functionality of more than 2 isocyanate groups in each molecule. The first are for example polyisocyanates which are obtained by modifying simple aliphatic, cycloaliphatic, araliphatic and/or aromatic diisocyanates and which comprise at least two diisocyanates with a uretdione, isocyanurate, urethane, allophanate, biuret, carbodiimide, iminooxadiazinedione and/or oxadiazinetrione structure. As an example of a non-modified polyisocyanate having more than 2 isocyanate groups in each molecule there may for example be mentioned 4-isocyanatomethyl-1,8-octane diisocyanate (nonane triisocyanate).

The content of component (B) in the polyurethane is, in some cases, from 5 to 60, from 6 to 45, or, in some cases, from 7 to 25 wt. %.

Suitable components (C) are for example components containing sulfonate or carboxylate groups, such as diamine compounds or dihydroxyl compounds which additionally contain sulfonate and/or carboxylate groups, such as the sodium, lithium, potassium, t-amine salts of N-(2-aminoethyl)-2-aminoethane sulfonic acid, N-(3-aminopropyl)-2-aminoethane sulfonic acid, N-(3-aminopropyl)-3-aminopropane sulfonic acid, N-(2-aminoethyl)-3-aminopropane sulfonic acid, analogous carboxylic acids, dimethylol propionic acid, dimethylol butyric acid, the reaction products from a Michael addition of 1 mol of diamine such as 1,2-ethane diamine or isophorone diamine with 2 mol of acrylic acid or maleic acid.

The acids are frequently used directly in the form of their salt as a sulfonate or carboxylate. However, it is also possible to add the neutralizing agent needed for formation of the salt in portions or in its entirety only during or after the polyurethanes have been prepared.

For forming salts, particularly suitable and preferred tert. amines are for example triethylamine, dimethyl cyclohexylamine and ethyl diisopropylamine. It is also possible to use other amines for the salt formation, such as ammonia, diethanolamine, triethanolamine, dimethylethanolamine, methyldiethanolamine, aminomethyl propanol, and also mixtures of the said and indeed other amines. It is sensible to add these amines only after the prepolymer has been formed.

It is also possible to use other neutralizing agents, such as sodium, potassium, lithium or calcium hydroxide for neutralizing purposes.

Other suitable components (C) are mono- or difunctional polyethers which have a non-ionic hydophilising action and are based on ethylene oxide polymers or ethylene oxide/propylene oxide copolymers which are started on alcohols or amines, such as POLYETHER LB 25 (Covestro AG) or MPEG 750: methoxypolyethylene glycol, molecular weight 750 g/mol (e.g. PLURIOL 750, BASF AG).

In some cases, the content of component (C) in the polyurethane is 0.1 to 15 wt. %, 0.5 to 10 wt. %, 0.8 to 5 wt. % or, in some cases, 0.9 to 3.0 wt. %.

Suitable components (D) are mono-, di-, trifunctional amines and/or mono-, di-, trifunctional hydroxylamines, such as aliphatic and/or alicyclic primary and/or secondary monoamines such as ethylamine, diethylamine, isomeric propyl and butyl amines, higher linear aliphatic monoamines and cycloaliphatic monoamines such as cyclohexylamine. Further examples are amino alcohols, that is compounds which contain amino and hydroxyl groups in one molecule, such as ethanolamine, N-methyl ethanolamine, diethanolamine, diisopropanolamine, 1,3-diamino-2-propanol, N-(2-hydroxyethyl)-ethylene diamine, N,N-bis(2-hydroxyethyl)-ethylene diamine and 2-propanolamine. Further examples are diamines and triamines, such as 1,2-ethane diamine, 1,6-hexamethylene diamine, 1-amino-3,3,5-trimethyl-5-aminomethyl cyclohexane (isophorone diamine), piperazine, 1,4-diamino cyclohexane, bis-(4-aminocyclohexyl)-methane and diethylene triamine. Also possible are adipic acid dihydrazide, hydrazine and hydrazine hydrate. Mixtures of a plurality of the compounds (D), optionally also those with compounds that are not mentioned, may also be used.

Compounds (D) may serve as chain extenders for creating higher molecular weights or as monofunctional compounds for limiting molecular weights and/or optionally additionally for incorporating further reactive groups, such as free hydroxyl groups as further crosslink points.

In some cases, the content of component (D) in the polyurethane is from 0 to 10, 0 to 5, or, in some cases, from 0.2 to 3 wt. %.

Component (E) which may optionally also be used may for example be aliphatic, cycloaliphatic or aromatic monoalcohols having 2 to 22 C atoms, such as ethanol, butanol, hexanol, cyclohexanol, isobutanol, benzyl alcohol, stearyl alcohol, 2-ethyl ethanol, cyclohexanol; blocking agents which are conventional for isocyanate groups and may be split again at elevated temperature, such as butanone oxime, dimethylpyrazole, caprolactam, malonic esters, triazole, dimethyl triazole, t-butyl-benzyl amine, cyclopentanone carboxyethyl ester.

In some cases, the content of components (E) in the polyurethane is from 0 to 20, in some cases from 0 to 10 wt. %.

The polyurethane dispersions often have solids contents of from 15 to 70 wt. %, from 25 to 60 wt. %, or, in some cases, from 30 to 50 wt. %. The pH is often in the range from 4 to 11, such as from 6 to 10.

Waterborne polyurethane dispersions may be prepared such that the components (A), (B) optionally (C) and optionally (E) are reacted in a single-stage or multi-stage reaction to give an isocyanate-functional prepolymer which is then, optionally with component (C) and optionally (D), reacted in a single-stage or two-stage reaction and then dispersed in or using water, wherein solvent used therein may optionally be removed, partially or entirely, by distillation during or after the dispersion.

Waterborne polyurethane or polyurethane urea dispersions may be prepared by methods described in Methoden der organischen Chemie (Houben-Weyl, supplemental volumes to the 4th edition, Volume E20, H. Bartl and J. Falbe, Stuttgart, New York, Thieme 1987, pp. 1671-1682).

Suitable polyurethane dispersions are commercially available and include those found under the BAYHYDROL, DISPERCOLL and IMPRANIL tradenames from Covestro.

It will be appreciated that other components may be utilized for other products, such as foams, including polyurethane foams, as well as other types of coatings, for example.

Referring back again to FIG. 12, a user may refer to the value of the formula ID to specify the specified values of the physical properties as shown. To the right of the chart are some interfaces that allow the user to save or delete the formulas. When the user is ready, a checkout or shopping cart icon allows the user to purchase the selected coating formula from a merchant that controls this gauge interface.

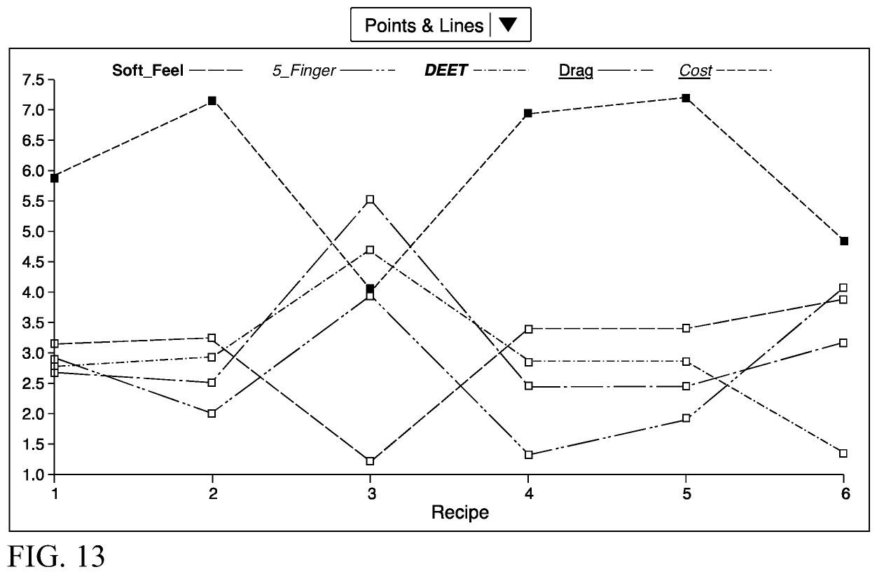

Referring to FIG. 13, the example illustration shows another chart that visually illustrates any number of coating formulations or recipes, according to some aspects. The chart shown provides a series of line graphs that visually depict the values of each type of qualitative description, across each coating formulation. The x-axis lists each coating formulation, expressed as a “recipe.” The recipes in this example correspond to the generated coating formulations identified as “Formula ID” in FIG. 12. Each recipe has five properties, corresponding to the five gauges in the gauge interface consistent with FIGS. 1-11. Each line represents one of the properties, according to the legend shown at the top of the chart. The y-axis represents the numerical values of any property that is consistent with the values in the five gauges in the gauge interface consistent with FIGS. 1-11. Therefore, one line in the chart of FIG. 13 represents the different values of a single property across each of the different recipes. If a coating formulation is added or deleted in the interface shown in FIG. 12, that change may be reflected in the line chart shown herein, according to some aspects. This line chart provides a visual depiction to see more easily a comparison of predicted properties of each of the formulations from one another.

In some aspects, a digital formulation service is provided for generating optimized material configurations, both in types of materials and cost. A computerized system may be configured to provide a digital formulation service module that allows a user to generate a custom material configuration based on a specified constraint, such as cost or performance. The digital formulation service may provide a recommended material configuration that satisfies the specified constraint. The digital formulation service module may be an augmented or supplemental service with the other user interfaces described herein, such as those described in FIGS. 1-13. For example, after developing a custom coating using the gauge interfaces described in FIGS. 1-11, the digital formulation service may be configured to transmit the custom formulation to one or more entities that facilitate supplying the materials and sending the materials to the customer. Examples of these models for completing the customer order will be described more, below.

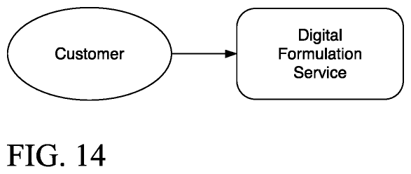

FIG. 14 shows a basic block diagram of a user or customer interfacing with the digital formulation service, which may be manifested in a computerized module. In this context, the digital formulation service may provide custom material configurations in a wide variety of ways. In some aspects, the digital formulation service is configured to generate a material configuration by optimizing based on cost of the ingredients to make the material. For example, to generate a custom coating, the customer may specify to the digital formulation service module to provide a recommended coating recipe that gives the best performance at a specified cost, or in other cases, at the lowest cost. In some aspects, the service module may provide the recommended recipe at the specified cost using default ingredients, since no other constraints may be specified.

In some aspects, the digital formulation service module may be configured to generate a material configuration, such as a custom coating, by optimizing formulation based on performance. In this example, the user may specify one or more criteria that one or more of the particular qualities of a coating must satisfy. For example, the user may specify that the custom coating must possess at least a minimum amount of smoothness, or must resist DEET at a particular minimum level. The digital formulation service module is then configured to analyze all known recipes, in some cases using just default ingredients, satisfying the performance constraint(s). The module then may provide a recommendation at the least expensive cost. The known recipes may be based on empirical research and tabulation that are stored in a database.

In some aspects, the digital formulation service module may also be configured to provide optimization configurations using substitute ingredients. For example, if a user instructs the service module to generate a custom coating by optimizing the formulation based on performance, the user may also specify to analyze all known recipes to satisfy the performance constraint using default ingredients as well as all permutations of substitute ingredients. The substitute ingredients may be based on empirical research and knowledge of physical properties that are stored in a database.

In other cases, the customer may simply supply to the digital formulation service the specifications for performance with the full recipe and workup information for how to generate the desired custom coating. From here, the digital formulation service may determine the most efficient or effective method for obtaining the materials. For example, the ingredients may come from one or more sources, and it may not be relevant to the customer what the sources are, so long as the proper ingredients are obtained. Alternatively, the digital formulation service may allow for the customer to specify the sources for obtaining the ingredients.

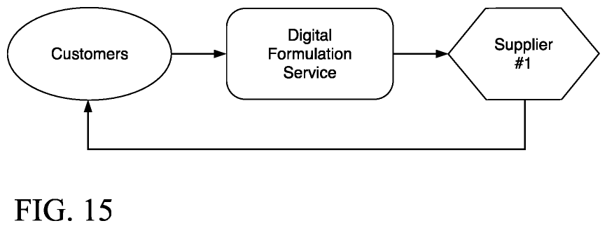

Referring to FIG. 15, shown is one model for how the digital formulation service may complete a custom coating order, according to some aspects. In the case where the customer specifies the coating performance by supplying the particular desired recipe, the digital formulation service may instruct a supplier to obtain the specific ingredients for the recipe. The digital formulation service may be able to access current inventory information from the supplier in order to determine if the order can be immediately fulfilled or if more efforts need to be taken to obtain particular ingredients. Ultimately, the supplier may be sent the customer shipping information and may send the raw materials (ingredients) to the customer.

In other cases, instead of being sent to a supplier, the digital formulation service may provide instructions for a manufacturing facility to generate the materials to complete the custom coating order. The instructions may be transmitted directly to manufacturing equipment of the facility, in some cases.

In another scenario, in the case where the customer may specify the performance of a coating but where the recipe information for the exact type of materials or ingredients is not specified, the digital formulation service may complete the order by performing optimization calculations to determine the best types of materials that satisfy the performance constraints. The gauge interfaces described in FIGS. 1-11 may be one example of how the performance constraints may be specified and then the types of materials may be determined thereafter. The digital formulation service may pass on a recipe based on this to the supplier. The supplier may then fulfill the order and send to the customer the raw materials and/or blends to the customer. The supplier may also send full coating systems to the customer, based on the received recipe from the digital formulation service.

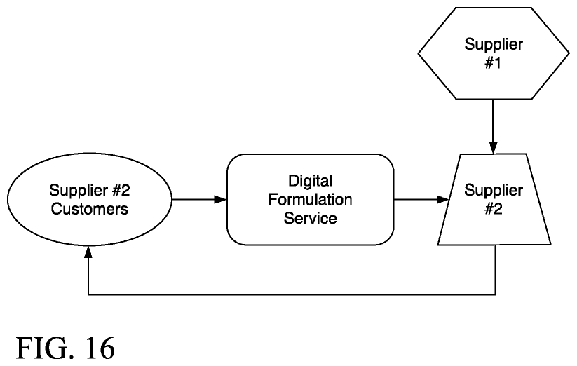

Referring to FIG. 16, shown is a second model in a variation of how the digital formulation service may complete a custom coating order, according to some aspects. In this example, customers of a second supplier may also use the digital formulation service, and may expect to receive orders fulfilled by the second supplier (supplier #2), such as a system house. The digital formulation service may be controlled by the first supplier (supplier #1), but may be utilized by the second supplier. The first supplier may supply the raw materials to the second supplier so that the second supplier can complete the order to their customers, as their customers expect. Thus, the second supplier may send the custom raw materials and/or blends to the customer. The second supplier may also supply full coating systems to the customer. This type of model enables the digital formulation service to be utilized by other entities that do not control or own the digital formulation service, so that more customers can still have access to the digital formulation service's capabilities.

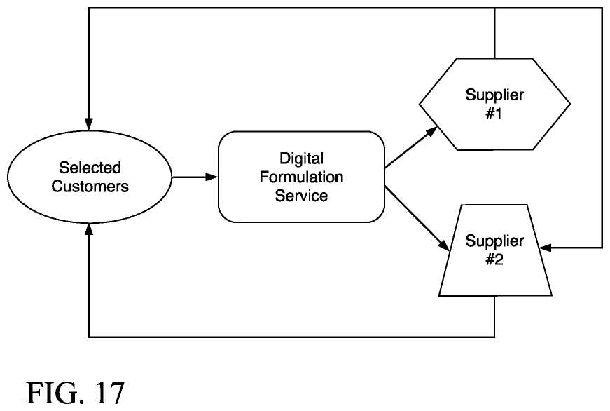

Referring to FIG. 17, shown is another model in another variation of how the digital formulation service may complete a custom coating order, according to some aspects. In this example, the digital formulation service may act as a neutral or hybrid platform that can send orders to different suppliers, depending on the need. For example, the digital formulation service may send custom coating recipes for high volume orders to the first supplier, while low volume orders may be sent to the second supplier. This may be most efficient because the first supplier may be larger and have more capacity to handle large orders, while the second supplier may be more specialized and/or have the supplies to handle smaller or more individualized orders. In some aspects, the second supplier may still lack certain materials or ingredients to fulfill even the small orders, and the first supplier may be configured to send the missing supplies to the second supplier to complete the order. Once the orders can be fulfilled, the first supplier may send the raw materials to the customer, and similarly the second supplier may also send the raw materials and/or blends to the customer. Full coatings systems may also be supplied to the customer by the second or first supplier.

In some aspects, in another variation of the neutral or hybrid platform, the digital formulation service may be configured to send orders to either the first or second supplier based on a competitive bidding process undertaken by the first and second (and possibly additional) suppliers. The bidding system may be setup as an automatic bidding system, where analysts from the different suppliers may input automatic bidding rules for various types of recipes or materials. The bidding process may be resolved automatically as part of the process to complete the customer order. In other cases, the bidding process may be conducted more manually, and the digital formulation service may be configured to provide the forum to conduct this process. The winning bid may be the bid that offers to fulfill the order at the lowest cost to the customer.

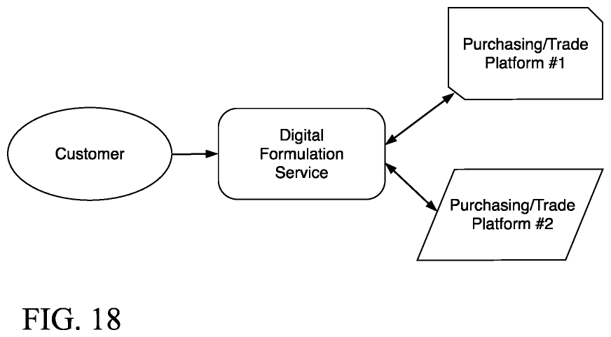

Referring to FIG. 18, in another variation, after generating a recommended material configuration satisfying user specified constraint(s), the digital formulation service module may be configured to interface with one or more purchasing/trade platforms that supply the ingredients needed to generate the recommended formulation, according to some aspects. The digital formulation service module may conduct a comparison of prices for the ingredients offered by the purchasing/trade platforms, either individually or collectively, in order to obtain the lowest price for the customer. This function may be applied to both small and large volume purchases, but the process for conducting these purchases may differ. For example, the digital formulation service module may be configured to analyze different vendors that offer large volume purchases, or may initiate negotiations with a purchase/trade platform to obtain better prices for large volume purchases. In addition, customers who specify looking for large volume purchases may be offered advanced options for finding the best prices, such as examining sales, coupons, and specialized discounts based on the customer's status or other known advantages.

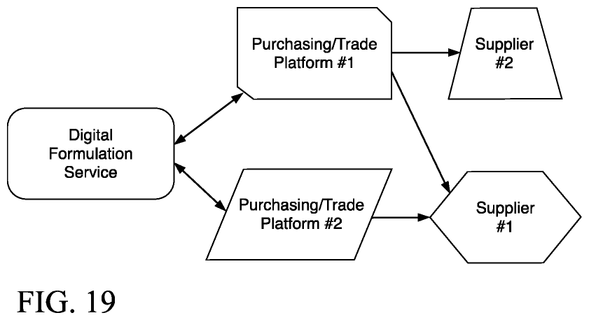

Referring to FIG. 19, in some aspects, the purchase mechanisms can be extended to include convenient and more streamlined features that can automatically connect to appropriate suppliers. After determining pricing, and depending on the purchasing/trade platform that will be used to purchase from for the desired order, one or more suppliers may be chosen from to fulfill the order. In some aspects, a purchasing/trade platform may be in contact with more than one supplier, such as Supplier #1 and Supplier #2 as shown, in order to handle different sizes of orders or address orders that have unique types of ingredients or parts. In some aspects, the digital formulation service may allow for a “touchless” order where there is a default purchasing platform and supplier used to fulfill orders by default.

In general, instead of, or in addition to, being sent to one or more suppliers, the digital formulation service may provide instructions for a manufacturing facility to generate the materials to complete the custom coating order, according to some aspects. The instructions may be transmitted directly to manufacturing equipment of the facility, in some cases.

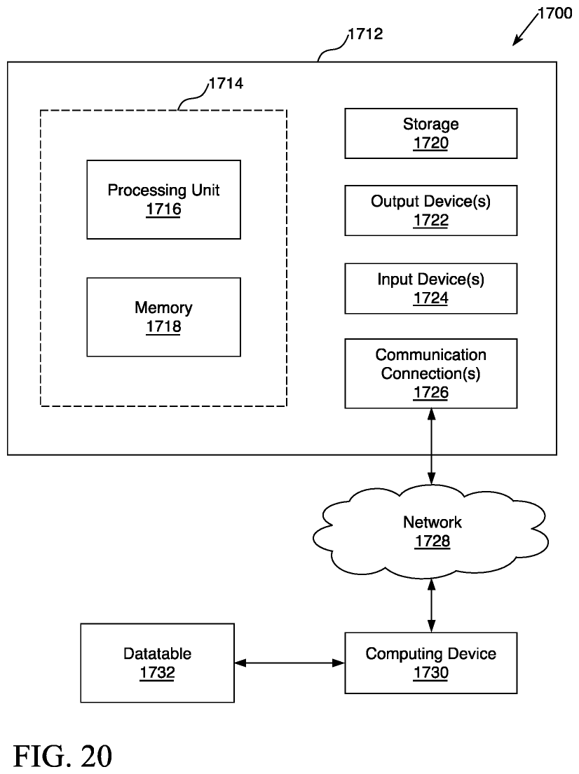

FIG. 20 illustrates an example computing environment 1700 wherein one or more of the aspects set forth herein may be implemented. FIG. 20 illustrates an example of a system 1700 comprising a computing device 1712 configured to implement one or more aspects provided herein. In one configuration, the computing device 1712 includes at least one processing unit 1716 and a memory 1718. Depending on the exact configuration and type of computing device, the memory 1718 may be volatile (such as RAM, for example), non-volatile (such as ROM, flash memory, etc., for example) or some combination of the two. This configuration is illustrated in FIG. 20 by a dashed line 1714.

In other aspects, the computing device 1712 may include additional features and/or functionality. For example, the computing device 1712 also may include additional storage (e.g., removable and/or non-removable) including, but not limited to, magnetic storage, optical storage, and the like. Such additional storage is illustrated in FIG. 20 by storage 1720. In one aspect, computer readable instructions to implement one or more aspects provided herein may be stored in the storage 1720. The storage 1720 also may store other computer readable instructions to implement an operating system, an application program, and the like. Computer readable instructions may be loaded in the memory 1718 for execution by the processing unit 1716, for example.

The term “computer readable media” as used herein includes computer storage media. Computer storage media includes volatile and nonvolatile, removable and non-removable media implemented in any method or technology for storage of information such as computer readable instructions or other data. The memory 1718 and the storage 1720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by the computing device 1712. Computer storage media does not, however, include propagated signals. Rather, computer storage media excludes propagated signals. Any such computer storage media may be part of the computing device 1712.

The computing device 1712 also may include one or more communication connection(s) 1726 that allows the computing device 1712 to communicate with other devices such as the computing device 1730. The communication connection(s) 1726 may include, but is not limited to, a modem, a Network Interface Card (NIC), an integrated network interface, a radio frequency transmitter/receiver, an infrared port, a USB connection, or other interfaces for connecting the computing device 1712 to other computing devices. The communication connection(s) 1726 may include a wired connection or a wireless connection. The communication connection(s) 1726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed so as to encode information in the signal.

The computing device 1712 may include one or more input device(s) 1724 such as keyboard, mouse, pen, voice input device, touch input device, infrared cameras, video input devices, and/or any other input device. Output input device(s) 1722 such as one or more displays, speakers, printers, and/or any other output device may also be included in the computing device 1712. The one or more input device(s) 1724 and one or more output device(s) 1722 may be connected to the computing device 1712 via a wired connection, wireless connection, or any combination thereof. In one aspect, an input device or an output device from another computing device may be used as the input device(s) 1724 or the output device(s) 1722 for the computing device 1712.

Components of the computing device 1712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another aspect, components of the computing device 1712 may be interconnected by a network, e.g., the memory 1718 may be comprised of multiple physical memory units located in different physical locations interconnected by a network.

Storage devices utilized to store computer readable instructions may be distributed across a network. For example, a computing device 1730 accessible via a network 1728 may store computer readable instructions to implement one or more aspects provided herein. The computing device 1712 may access the computing device 1730 and download a part or all of the computer readable instructions for execution. Alternatively, computing device 1712 may download pieces of the computer readable instructions, as needed, or some instructions may be executed at the computing device 1712 and some at the computing device 1730. The computing device 1730 may be coupled to a stored data table 1732. The contents of the data table 1732 can be accessed by both computing devices 1712, 1730. In one aspect, the data table 1732 stores the property and formulation data set that is used to generate the gauges and recipes described herein. The data table 1732 may be employed to store the data tables described herein.

The computing device 1730 may include all or some of the components of the computing device 1712. For example, the computing device 1730 may include at least one processing unit and a memory, e.g., a volatile memory (such as RAM, for example), a non-volatile memory (such as ROM, flash memory, for example) or some combination of the two. In other aspects, the computing device 1730 may include additional storage (e.g., removable and/or non-removable) including, but not limited to, magnetic storage, optical storage, and the like. In one aspect, computer readable instructions to implement one or more aspects provided herein may be stored in the storage. The storage also may store other computer readable instructions to implement an operating system, an application program, and the like. Computer readable instructions may be loaded in the memory for execution by the processing unit, for example.

The computing device 1730 also may include one or more communication connection(s) that allows the computing device 1730 to communicate with other devices such as the computing device 1712. The communication connection(s) may include, but is not limited to, a modem, a Network Interface Card (NIC), an integrated network interface, a radio frequency transmitter/receiver, an infrared port, a USB connection, or other interfaces for connecting the computing device 1730 to other computing devices. The communication connection(s) may include a wired connection or a wireless connection. The communication connection(s) may transmit and/or receive communication media.

The computing device 1730 may include one or more input device(s) such as keyboard, mouse, pen, voice input device, touch input device, infrared cameras, video input devices, and/or any other input device. Output input device(s) such as one or more displays, speakers, printers, and/or any other output device may also be included in the computing device 1730. The one or more input device(s) and one or more output device(s) may be connected to the computing device via a wired connection, wireless connection, or any combination thereof. In one aspect, an input device or an output device from another computing device may be used as the input device(s) or the output device(s) for the computing device 1730.

Components of the computing device 1730 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another aspect, components of the computing device 1730 may be interconnected by a network. For example, the memory may be comprised of multiple physical memory units located in different physical locations interconnected by a network.

In one aspect, the processing unit 1716 may be configured to generate a plurality of values of a property of a material that includes, without limitation, a foam, a coating, an adhesive, a sealant, an elastomer, a sheet, a film, a binder, or any organic polymer. In one aspect, the processing unit 1716 may be configured to generate a model for generating a plurality of gauges. In one aspect, the processing unit 1716 generates the model based on design of experiments, regression analysis of a data set, an equation, machine learning, or artificial intelligence, and/or any combination thereof.

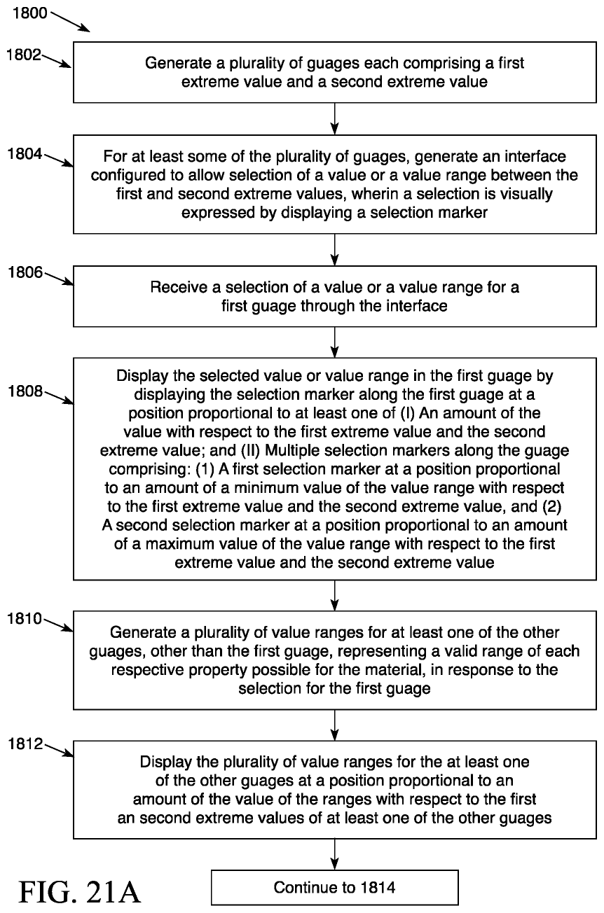

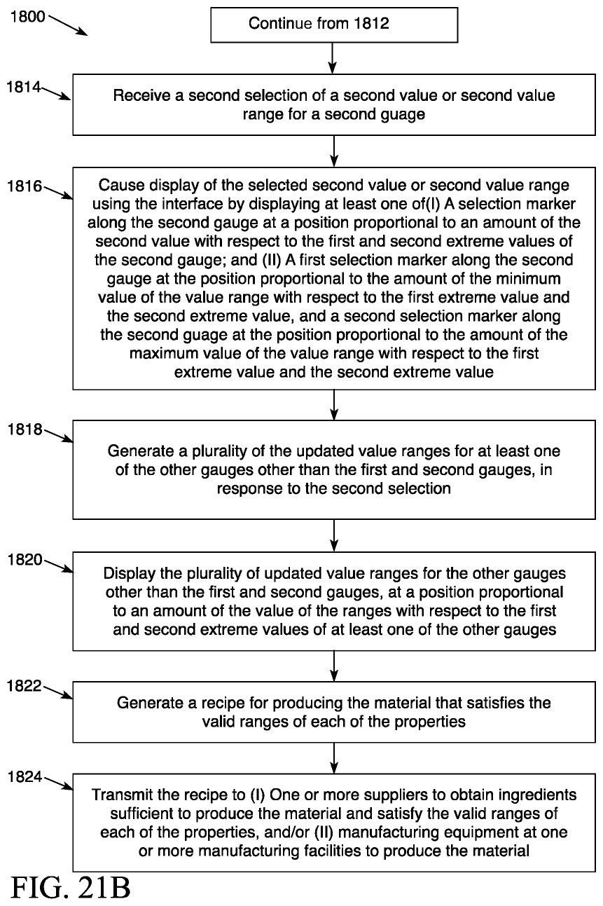

FIGS. 21A and 21B combined show a logic flow diagram of a logic configuration or process 1800 of a method of producing a graphical depiction of a plurality of values of a property of a material according to one aspect of this disclosure. The process 1800 may be executed in the computing environment 1700 described in connection with FIG. 20 based on executable instructions stored in the memory 1718 or the storage 1720. Input from the user is received by the processing unit 1716 from the input device(s) 1724. The computing device 1712 may be a client computer in communication with the computing device 1730 which may be a server coupled to a data table 1732 containing a dataset to a visual representation of the dataset. As previously discussed, the dataset may be generated by a variety of techniques, including, without limitation, design of experiments, regression analysis of a data set, an equation, machine learning, or artificial intelligence, and/or any combination thereof. In one aspect, a model may be used to generate the values of the properties for a visual representation generated from a design of experiment technique. In other aspects, models for generating predictive values of properties include a statistical analysis of unstructured data, such as that generated by a historian of a distributed control system of a chemical manufacturing plant.

According to the process 1800, the processing unit 1716 generates 1802 a plurality of gauges each comprising a first extreme value and a second extreme value, each of the gauges representing a property about the material. The material may be a haptic coating, but the invention is not so limited (for example, the material could be a different category of coatings, such as a polyaspartic floor coating among many others, or could be another other materials, such as adhesives, sealants or foams). The plurality of properties may include a measure of softness, scratch resistance, DEET resistance, smoothness and cost, but the invention is not so limited. One or more combinations of two or more such properties may be employed either alone or in combination with other properties, or completely different properties may be employed, if desired. In some cases, the first extreme value represents one side of a qualitative description about the property, and the second extreme value represents an opposite side of the qualitative description about the property and the first extreme value is positioned at one end of the gauge and the second extreme value is positioned at an opposite end of the gauge. Alternatively, the first extreme value could represent a minimum quantitative amount of the property, and the second extreme value could represent a maximum quantitative amount of the property and the minimum quantitative amount is positioned at one end of the gauge and the maximum quantitative amount is positioned at an opposite end of the gauge.

According to the process 1800, the processing unit 1716 generates 1804, for at least some, in some cases each, of the plurality of gauges, an interface configured to allow selection of a value in between the first extreme value and the second extreme value and the selection of the value is visually expressed by displaying a selection marker along the gauge at a position proportional to an amount of the value with respect to the first extreme value and the second extreme value.

Next, according to the process 1800, a selection of the value for a first gauge among a plurality of gauges is received 1806 through an interface.

According to the process 1800, the selected value in the first gauge is displayed 1808 using the interface by displaying the selection marker along the first gauge at a position proportional to the amount of the value with respect to the first extreme value and the second extreme value. Then, according to the process 1800, a plurality of value ranges for at least one of the other gauges other than the first gauge is generated 1810 by the processing unit 1716 in response to the received selection. Here, each of the value ranges represents a valid range of each respective property that is possible for the material, given that the selection of the value for the first gauge is a constraint that must be present in the material.

Next, according to process 1800, the plurality of value ranges for the at least one of the other gauges at a position proportional to an amount of the value of the ranges with respect to the first extreme value and second extreme value of the at least one of the other gauges is displayed 1812.

Continuing to FIG. 17B, according to some implementations, the process 1800 may further include receiving 1814, through the interface, a second selection of a second value for a second gauge among the plurality of gauges and causing 1816 display of the selected second value in the second gauge using the interface by displaying a second selection marker along the second gauge at a position proportional to an amount of the second value with respect to the first extreme value and the second extreme value of the second gauge. Next, the process 1800 may include generating 1818, by the processing unit 1716, and in response to the received second selection, a plurality of updated value ranges for at least one of the other gauges other than the first gauge and the second gauge, wherein each of the updated value ranges represents a valid range of each respective property that is possible for the material, given that the selection of the value for the first gauge and the second value of the second gauge are constraints that must be present in the material. In addition, in some implementations, the process 1800 may include displaying 1820 the plurality of updated value ranges for the at least one of the other gauges that are updated, other than the first gauge and the second gauge, at a position proportional to an amount of the value of the ranges with respect to the first extreme value and second extreme value of the at least one of the other gauges. In such implementations, the second selection of the second value may be a value within a valid range associated with the second gauge that was generated in response to the selection of the first value.

Furthermore, according to some implementations, the process 1800 further includes generating 1822 a recipe for producing the material that satisfies the valid ranges of each of the properties and, in some cases, transmitting the recipe 1824 to one or more suppliers to obtain ingredients sufficient to produce the material satisfying the valid ranges of each of the properties. Here, the transmitting the recipe 1824 to the one or more suppliers may be based on, for example, determining a supplier that can obtain the ingredients at the lowest total cost, conducting a competitive bidding process between two or more suppliers, or determining which suppliers are capable of obtaining the ingredients sufficient to fulfill the recipe.

Various operations of aspects are provided herein. In one aspect, one or more of the operations described may constitute computer readable instructions stored on one or more computer readable media, which if executed by a computing device, will cause the computing device to perform the operations. The order in which some or all of the operations are described does not imply that these operations are necessarily order dependent. Alternative ordering will be appreciated by one skilled in the art having the benefit of this description. Further, it will be understood that not all operations are necessarily present in each aspect provided herein. Also, it will be understood that not all operations are necessary in some aspects.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” means an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

Various aspects of the subject matter described herein are set out in the following numbered examples:

Example 1. A method of producing a graphical depiction of a plurality of properties of a material, the method comprising: generating, by a processing unit, a plurality of gauges each comprising a first extreme value and a second extreme value, wherein each gauge represents a property about the material, wherein the first extreme value is positioned at one end of the gauge and the second extreme value is positioned at an opposite end of the gauge; generating, by the processing unit, for at least some of the plurality of gauges, an interface configured to allow selection of a value or a value range in between the first extreme value and the second extreme value, wherein the selection of the value or the value range is visually expressed by displaying at least one of: (i) a selection marker along the gauge at a position proportional to an amount of the value with respect to the first extreme value and the second extreme value, and (ii) multiple selection markers along the gauge comprising: (1) a first selection marker at a position proportional to an amount of a minimum value of the value range with respect to the first extreme value and the second extreme value, and (2) a second selection marker at a position proportional to an amount of a maximum value of the value range with respect to the first extreme value and the second extreme value; receiving, through the interface, a selection of the value for a first gauge among the plurality of gauges; causing display of the selected value or value range in the first gauge using the interface by displaying at least one of: (i) the selection marker along the gauge at the position proportional to the amount of the value with respect to the first extreme value and the second extreme value, and (ii) the first selection marker along the gauge at the position proportional to the amount of the minimum value of the value range with respect to the first extreme value and the second extreme value, and the second selection marker at the position proportional to the amount of the maximum value of the value range with respect to the first extreme value and the second extreme value; in response to the received selection, generating, by the processing unit, a plurality of value ranges for each of the other gauges other than the first gauge, wherein each of the value ranges represents a valid range of each respective property that is possible for the material, given that the selection of the value or the value range for the first gauge is a constraint that must be present in the material; and causing display of the plurality of valid ranges for each of the other gauges at a position proportional to an amount of the value of the ranges with respect to the first extreme value and second extreme value of each of the other gauges.

Example 2. The method of Example 1, wherein the first extreme value represents one side of a qualitative description about the property, and the second extreme value represents an opposite side of the qualitative description about the property.

Example 3. The method of Example 1 or Example 2, further comprising: receiving, through the interface, a second selection of a second value or second value range for a second gauge among the plurality of gauges; causing display of the selected second value or second value range in the second gauge using the interface by displaying at least one of: (i) a selection marker along the second gauge at the position proportional to the amount of the second value with respect to the first extreme value and the second extreme value of the second gauge, and (ii) a first selection marker along the second gauge at the position proportional to the amount of the minimum value of the value range with respect to the first extreme value and the second extreme value, and a second selection marker along the second gauge at the position proportional to the amount of the maximum value of the value range with respect to the first extreme value and the second extreme value; in response to the received second selection, generating, by the processing unit, a plurality of updated value ranges for each of the other gauges other than the first gauge and the second gauge, wherein each of the updated value ranges represents a valid range of each respective property that is possible for the material, given that the selection of the value or value range for the first gauge and the second value or value range of the second gauge are constraints that must be present in the material; and causing display of the plurality of updated valid ranges for each of the other gauges, other than the first gauge and the second gauge, at a position proportional to an amount of the value of the ranges with respect to the first extreme value and second extreme value of each of the other gauges.

Example 4. The method of Example 3, wherein the second selection of the second value or value range is a value or value range within a valid range associated with the second gauge that was generated in response to the selection of the first value.

Example 5. The method of any one of Example 1 to Example 4, wherein the gauges have a rounded or linear shape.

Example 6. The method of Example 5, wherein the gauges have a rounded shape that is a half-circle.

Example 7. The method of one of Example 1 to Example 6, wherein the material comprises a haptic coating material.

Example 8. The method of one of Example 1 to Example 7, wherein the plurality of properties comprise a combination of any two or more of (i) a measure of softness, (ii) a measure of scratch resistance, (iii) a measure of DEET resistance, and (iv) a measure of smoothness.

Example 9. The method of Example 8, wherein the plurality of properties further comprise a cost of the material per unit mass.

Example 10. The method of one of Example 8 or Example 9, wherein the gauge corresponding to the measure of softness property comprises a first extreme value representing a rubbery softness feeling and a second extreme value representing a hard feeling.

Example 11. The method of one of Example 8 to Example 10, wherein the gauge corresponding to the measure of scratch resistance property comprises a first extreme value representing no scratch resistance and a second extreme value representing extreme scratch resistance.

Example 12. The method of one of Example 8 to Example 11, wherein the gauge corresponding to the measure of DEET resistance property comprises a first extreme value representing poor quality DEET resistance and a second extreme value representing good quality DEET resistance.

Example 13. The method of one of Example 8 to Example 12, wherein the gauge corresponding to the measure of smoothness property comprises a first extreme value representing low drag and a second extreme value representing high drag.

Example 14. The method of one of Example 1 to Example 6, wherein the material comprises a floor coating material.

Example 15. The method of one of Example 1 to Example 14, wherein the selected value range is a pre-set value range.

Example 16. The method of one of Example 1 to Example 15, wherein the selected value range is a user-defined value range.

Example 17. The method of one of Example 1 to Example 16, wherein the value range in between the first extreme value and the second extreme value is selected and the method further comprises: receiving, through the interface, a selection of an optimized value for the selected value range for the first gauge; causing display of the selected optimized value in the first gauge using the interface by displaying a selection marker along the gauge at the position proportional to the amount of the optimized value with respect to the first extreme value and the second extreme value; in response to the received selection, generating, by the processing unit, a value for at least one of the other gauges other than the first gauge, wherein each of the generated values represents a valid value of each respective property that is possible for the material, given that the selection of the optimized value for the first gauge is a constraint that must be present; and causing display of the generated value for the at least one of the other gauges using the interface by displaying a selection marker along the gauge at a position proportional to an amount of the value with respect to the first extreme value and second extreme value of the at least one of the other gauges.

Example 18. The method of one of Example 1 to Example 17, wherein the plurality of updated value ranges is generated based on design of experiments, regression analysis of a data set, an equation, machine learning, or artificial intelligence, and/or any combination thereof.

Example 19. The method of one of Example 1 to Example 18, further comprising: generating a recipe for producing the material that satisfies the valid ranges of each of the properties

Example 20. The method of Example 19, further comprising transmitting the recipe to one or more suppliers to obtain ingredients sufficient to produce the material and satisfy the valid ranges of each of the properties.

Example 21. The method of Example 20, wherein transmitting the recipe to the one or more suppliers is based on determining a supplier that can obtain the ingredients at the lowest total cost.

Example 22. The method of Example 20, wherein transmitting the recipe to the one or more suppliers is based on conducting a competitive bidding process between two or more suppliers.

Example 23. The method of Example 20, wherein transmitting the recipe to the one or more suppliers is based on determining which suppliers are capable of obtaining the ingredients sufficient to fulfill the recipe.

Example 24. A graphical user interface (GUI) configured to provide a graphical depiction of a plurality of properties of a material, the GUI comprising: a plurality of gauges each comprising a first extreme value and a second extreme value, wherein each gauge represents a property about the material, wherein the first extreme value is positioned at one end of the gauge and the second extreme value is positioned at an opposite end of the gauge; for at least some of the plurality of gauges, an interface configured to allow selection of a value or a value range in between the first extreme value and the second extreme value, wherein the selection of the value or the value range is visually expressed by displaying at least one of: (i) a selection marker along the gauge at a position proportional to an amount of the value with respect to the first extreme value and the second extreme value, and (ii) multiple selection markers along the gauge comprising: (1) a first selection marker at a position proportional to an amount of a minimum value of the value range with respect to the first extreme value and the second extreme value, and (2) a second selection marker at a position proportional to an amount of a maximum value of the value range with respect to the first extreme value and the second extreme value; wherein the GUI is configured to: receive a selection of the value or the value range for a first gauge among the plurality of gauges; cause display of the selected value or value range in the first gauge using the interface by displaying at least one of: (i) the selection marker along the gauge at the position proportional to the amount of the value with respect to the first extreme value and the second extreme value, and (ii) the first selection marker along the gauge at the position proportional to the amount of the minimum value of the value range with respect to the first extreme value and the second extreme value, and the second selection marker at the position proportional to the amount of the maximum value of the value range with respect to the first extreme value and the second extreme value; in response to the received selection, generate a plurality of value ranges for each of the other gauges other than the first gauge, wherein each of the value ranges represents a valid range of each respective property that is possible for the material, given that the selection of the value or the value range for the first gauge is a constraint that must be present in the material; and cause display of the plurality of valid ranges for each of the other gauges at a position proportional to an amount of the value of the ranges with respect to the first extreme value and second extreme value of each of the other gauges.

Example 25. The GUI of Example 24, wherein the first extreme value represents one side of a qualitative description about the property, and the second extreme value represents an opposite side of the qualitative description about the property.

Example 26. The GUI of Example 24 or Example 25, further configured to: receive a second selection of a second value or second value range for a second gauge among the plurality of gauges; cause display of the selected second value or second value range in the second gauge using the interface by displaying at least one of: (i) a selection marker along the second gauge at the position proportional to the amount of the second value with respect to the first extreme value and the second extreme value of the second gauge, and (ii) a first selection marker along the second gauge at the position proportional to the amount of the minimum value of the value range with respect to the first extreme value and the second extreme value, and a second selection marker along the second gauge at the position proportional to the amount of the maximum value of the value range with respect to the first extreme value and the second extreme value; in response to the received second selection, generate a plurality of updated value ranges for each of the other gauges other than the first gauge and the second gauge, wherein each of the updated value ranges represents a valid range of each respective property that is possible for the material, given that the selection of the value or the value range for the first gauge and the second value or second value range of the second gauge are constraints that must be present in the material; and cause display of the plurality of updated valid ranges for each of the other gauges, other than the first gauge and the second gauge, at a position proportional to an amount of the value of the ranges with respect to the first extreme value and second extreme value of each of the other gauges.

Example 27. The GUI of Example 26, wherein the second selection of the second value or second value range is a value or value range within a valid range associated with the second gauge that was generated in response to the selection of the first value or first value range.

Example 28. The GUI of one of Example 24 to Example 27, wherein the gauges have a rounded or linear shape.

Example 29. The GUI of Example 28, wherein the gauges have a rounded shape that is a half-circle.

Example 30. The GUI of one of Example 24 to Example 29, wherein the material comprises a haptic coating material.

Example 31. The GUI of Example 30, wherein the plurality of properties comprise a combination of any two or more of (i) a measure of softness, (ii) a measure of scratch resistance, (iii) a measure of DEET resistance, and (iv) a measure of smoothness.

Example 32. The GUI of Example 31, wherein the plurality of properties further comprise a cost of the material per unit mass.

Example 33. The GUI of Example 31 or Example 32, wherein the gauge corresponding to the measure of softness property comprises a first extreme value representing a rubbery softness feeling and a second extreme value representing a hard feeling.

Example 34. The GUI of one of Example 31 to Example 33, wherein the gauge corresponding to the measure of scratch resistance property comprises a first extreme value representing no scratch resistance and a second extreme value representing extreme scratch resistance.

Example 35. The GUI of one of Example 31 to Example 34, wherein the gauge corresponding to the measure of DEET resistance property comprises a first extreme value representing poor quality DEET resistance and a second extreme value representing good quality DEET resistance.

Example 36. The GUI of one of Example 31 to Example 35, wherein the gauge corresponding to the measure of smoothness property comprises a first extreme value representing low drag and a second extreme value representing high drag.

Example 37. The GUI of one of Example 24 to Example 36, wherein the GUI is configured to generate the plurality of updated value ranges based on design of experiments, regression analysis of a data set, an equation, machine learning, or artificial intelligence, and/or any combination thereof.

Example 38. The GUI of one of Example 24 to Example 37, wherein the plurality of properties further comprise a cost of the material per unit mass.

Example 39. The GUI of one of Example 24 to Example 29, wherein the material comprises a floor coating material.

Example 40. The GUI of one of Example 24 to Example 39, wherein the selected value range is a pre-set value range.

Example 41. The GUI of one of Example 24 to Example 40, wherein the selected value range is a user-defined value range.

Example 42. The GUI of one of Example 24 to Example 41, wherein the value range in between the first extreme value and the second extreme value is selected and further comprising: receiving, through the interface, a selection of an optimized value for the selected value range for the first gauge; causing display of the selected optimized value in the first gauge using the interface by displaying a selection marker along the gauge at the position proportional to the amount of the optimized value with respect to the first extreme value and the second extreme value; in response to the received selection, generating, by the processing unit, a value for at least one of the other gauges other than the first gauge, wherein each of the generated values represents a valid value of each respective property that is possible for the material, given that the selection of the optimized value for the first gauge is a constraint that must be present; and causing display of the generated value for the at least one of the other gauges using the interface by displaying a selection marker along the gauge at a position proportional to an amount of the value with respect to the first extreme value and second extreme value of the at least one of the other gauges.

1. A method of producing a graphical depiction of a plurality of values of properties of a material, the method comprising:
generating, by a processing unit, a plurality of gauges each comprising a first extreme value and a second extreme value, wherein each gauge represents a property about the material, wherein the first extreme value is positioned at one end of the gauge and the second extreme value is positioned at an opposite end of the gauge;
generating, by the processing unit, for at least some of the plurality of gauges, an interface configured to allow selection of a value or a value range in between the first extreme value and the second extreme value, wherein the selection of the value or the value range is visually expressed by displaying at least one of:
(i) a selection marker along the gauge at a position proportional to an amount of the value with respect to the first extreme value and the second extreme value, and
(ii) multiple selection markers along the gauge comprising:
(1) a first selection marker at a position proportional to an amount of a minimum value of the value range with respect to the first extreme value and the second extreme value, and
(2) a second selection marker at a position proportional to an amount of a maximum value of the value range with respect to the first extreme value and the second extreme value;
receiving, through the interface, a selection of the value or the value range for a first gauge among the plurality of gauges;
causing display of the selected value or value range in the first gauge using the interface by displaying at least one of:
(i) the selection marker along the gauge at the position proportional to the amount of the value with respect to the first extreme value and the second extreme value, and
(ii) the first selection marker along the gauge at the position proportional to the amount of the minimum value of the value range with respect to the first extreme value and the second extreme value, and the second selection marker at the position proportional to the amount of the maximum value of the value range with respect to the first extreme value and the second extreme value;
in response to the received selection, generating, by the processing unit, a plurality of value ranges for at least one of the other gauges other than the first gauge, wherein each of the value ranges represents a valid range of each respective property that is possible for the material, given that the selection of the value or the value range for the first gauge is a constraint that must be present; and
causing display of the plurality of value ranges for the at least one of the other gauges at a position proportional to an amount of the value of the ranges with respect to the first extreme value and second extreme value of the at least one of the other gauges.

2. The method of claim 1, wherein the first extreme value represents one side of a qualitative description about the property and the second extreme value represents an opposite side of the qualitative description about the property.

3. The method of claim 1, further comprising:
receiving, through the interface, a second selection of a second value or second value range for a second gauge among the plurality of gauges;
causing display of the selected second value or second value range in the second gauge using the interface by displaying at least one of:
(i) a selection marker along the second gauge at the position proportional to the amount of the second value with respect to the first extreme value and the second extreme value of the second gauge, and
(ii) a first selection marker along the second gauge at the position proportional to the amount of the minimum value of the value range with respect to the first extreme value and the second extreme value, and a second selection marker along the second gauge at the position proportional to the amount of the maximum value of the value range with respect to the first extreme value and the second extreme value;
in response to the received second selection, generating, by the processing unit, a plurality of updated value ranges for at least one of the other gauges other than the first gauge and the second gauge, wherein each of the updated value ranges represents a valid range of each respective property that is possible for the material, given that the selection of the value or value range for the first gauge and the second value or value range of the second gauge are constraints that must be present in the material; and
causing display of the plurality of updated value ranges for the at least one of the other gauges that are updated, other than the first gauge and the second gauge, at a position proportional to an amount of the value of the ranges with respect to the first extreme value and second extreme value of the at least one of the other gauges.

4. The method of claim 3, wherein the second selection of the second value or value range is a value or value range within a valid range associated with the second gauge that was generated in response to the selection of the first value.

5. The method of claim 1, wherein the gauges have a rounded or linear shape.

6. The method of claim 1, wherein the gauges have a rounded shape that is a half-circle.

7. (canceled)

8. The method of claim 1, wherein the plurality of properties comprise a combination of any two or more of (i) a measure of softness, (ii) a measure of scratch resistance, (iii) a measure of DEET resistance, and (iv) a measure of smoothness.

9. The method of claim 8, wherein the plurality of properties further comprise a cost of the material per unit mass.

10. The method of claim 8, wherein the gauge corresponding to the measure of softness property comprises a first extreme value representing a rubbery softness feeling and a second extreme value representing a hard feeling.

11. The method of claim 8, wherein the gauge corresponding to the measure of scratch resistance property comprises a first extreme value representing no scratch resistance and a second extreme value representing extreme scratch resistance.

12. The method of claim 8, wherein the gauge corresponding to the measure of DEET resistance property comprises a first extreme value representing poor quality DEET resistance and a second extreme value representing good quality DEET resistance.

13. The method of claim 8, wherein the gauge corresponding to the measure of smoothness property comprises a first extreme value representing low drag and a second extreme value representing high drag.

14. (canceled)

15. The method of claim 1, wherein the selected value range is a pre-set value range.

16. The method of claim 1, wherein the selected value range is a user-defined value range.

17. The method of claim 1, the value range in between the first extreme value and the second extreme value is selected and further comprising:
receiving, through the interface, a selection of an optimized value for the selected value range for the first gauge;
causing display of the selected optimized value in the first gauge using the interface by displaying a selection marker along the gauge at the position proportional to the amount of the optimized value with respect to the first extreme value and the second extreme value;
in response to the received selection, generating, by the processing unit, a value for at least one of the other gauges other than the first gauge, wherein each of the generated values represents a valid value of each respective property that is possible for the material, given that the selection of the optimized value for the first gauge is a constraint that must be present; and
causing display of the generated value for the at least one of the other gauges using the interface by displaying a selection marker along the gauge at a position proportional to an amount of the value with respect to the first extreme value and second extreme value of the at least one of the other gauges.

18. The method of claim 1, wherein the plurality of updated value ranges is generated based on design of experiments, regression analysis of a data set, an equation, machine learning, or artificial intelligence, and/or any combination thereof.

19. The method of claim 1, further comprising:
generating a recipe for producing the material that satisfies the valid ranges of each of the properties

20. The method of claim 19, further comprising
transmitting the recipe to one or more suppliers to obtain ingredients sufficient to produce the material and satisfy the valid ranges of each of the properties.

21. The method of claim 20, wherein transmitting the recipe to the one or more suppliers is based on determining a supplier that can obtain the ingredients at the lowest total cost.

22. The method of claim 20, wherein transmitting the recipe to the one or more suppliers is based on conducting a competitive bidding process between two or more suppliers.

23.-39. (canceled)
